(19) United States
(12) Patent Application Publication
(10) Pub. No.: US 2024/0289545 A1
(43) Pub. Date: Aug. 29, 2024

(54) AUTOMATED PLAN GENERATION AND EXECUTION SYSTEM FOR LARGE LANGUAGE MODELS

(71) Applicant: MICROSOFT TECHNOLOGY LICENSING, LLC, Redmond, WA (US)

(72) Inventors: Leroy Ford MILLER, Tacoma, WA (US); Devis LUCATO, Redmond, WA (US); Shawn Cantin CALLEGARI, Bellevue, WA (US); Umesh MADAN, Bellevue, WA (US); Brian Scott KRABACH, Snohomish, WA (US); Mark KARLE, Seattle, WA (US)

(21) Appl. No.: 18/144,824

(22) Filed: May 8, 2023

Related U.S. Application Data
(60) Provisional application No. 63/449,035, filed on Feb. 28, 2023.

(51) Int. Cl. G06F 40/20; G06F 16/9032

(52) U.S. Cl. CPC G06F 40/20; G06F 16/90332

(57) ABSTRACT

Disclosed is a system for creating solution plans to solve problems in an AI system. An example system includes a large language model (LLM), a plan creation component, a plan working memory, and a plan execution component. The plan creation component leverages the power of the LLM to break problems into sets of discrete tasks, or solution plans, which are stored in the plan working memory. As each step of a solution plan is executed by the plan execution component, results are captured in the plan working memory so that the last executed step is captured. The working memory operates in the background of the AI system to ensure that the discrete tasks are executed, managed, and tracked until a complete solution is realized. The self-maintained working memory topology provides a solution to problems areas often encountered in conventional stateless AI system that encounter token limits in problem solving.

### CROSS-REFERENCE TO RELATED APPLICATIONS

The present application is a non-provisional application of, and claims priority to, U.S. Provisional Application Ser. No. 63/449,035 filed on Feb. 28, 2023, the contents of which are hereby incorporated by reference in their entirety.

### BACKGROUND

Artificial intelligence (AI) has a rich history, dating back to the mid-20th century when pioneers like John McCarthy and Marvin Minsky first began exploring the concepts. Initially, AI was seen as a way to replicate human intelligence in machines, and early efforts focused on developing systems that could perform tasks like playing chess or proving mathematical theorems.

Over the years, AI has evolved and expanded its focus to include a wide range of applications, from image recognition to natural language processing (NLP). Various AI systems and methods may now be applied in numerous domains.

Large language models (LLMs) are a recent development in the field of NLP. LLMs can apply deep learning algorithms, sometimes referred to as machine learning (ML), to leverage massive amounts of data, which can result in highly accurate language processing capabilities. Some example LLMs include GPT-3 and BERT, which are trained on vast amounts of text data, allowing them to model complex relationships in language and highly accurate predictions for a wide range of language tasks such as: translation, summarization, and responses to questions. This has led to breakthroughs in areas like chatbots, virtual assistants, and language-based recommendation systems.

Overall, LLMs represent a significant step forward in the field of NLP, which shows great potential to revolutionize the way we interact with machines. These LLMs can be extended via custom integration with other services and interfaces to provide robust applications. It is with respect to these and other considerations that the disclosure made herein is presented.

### SUMMARY

Disclosed is a system for creating solution plans to solve problems in an AI system. An example system includes a large language model (LLM), a plan creation component, a plan working memory, and a plan execution component. The plan creation component leverages the power of the LLM to break problems into sets of discrete tasks, or solution plans, which are stored in the plan working memory. As each step of a solution plan is executed by the plan execution component, results are captured in the plan working memory so that the last executed step is captured. The working memory operates in the background of the AI system to ensure that the discrete tasks are executed, managed, and tracked until a complete solution is realized. The self-maintained working memory topology provides a solution to problems areas often encountered in conventional stateless AI system that encounter token limits in problem solving.

In some embodiments, a method for an artificial intelligence (AI) system to automatically generate plans to solve problems, is described, the method comprising: receiving an initial user prompt by a plan creation component of the AI system; building a goal based on the initial user prompt by the plan creation component of the AI system; generating a solution plan based on the initial goal and the initial user prompt by the plan creation component of the AI system, wherein the plan creation component uses a large language mode (LLM) to generate a set of discrete steps for the solution plan to achieve the goal; storing the solution plan, the user prompt, and the goal in a plan working memory of the AI system; and sending a message to the user that is based on one or more of the solution plan and the goal.

In some additional embodiments, a computer-readable storage medium is described having computer-executable instructions stored thereupon that, when executed by a processing system, cause the processing system to: receive an initial user prompt by a plan creation component of the AI system; build a goal based on the initial user prompt by the plan creation component of the AI system; generate solution plan based on the initial goal and the initial user prompt by the plan creation component of the AI system, wherein the plan creation component uses a large language mode (LLM) to generate a set of discrete steps for the solution plan to achieve the goal; store the solution plan, the user prompt, and the goal in a plan working memory of the AI system; and send a message to the user that is based on one or more of the solution plan and the goal.

For the embodiments described herein, the AI system may or may not be required to provide the solution plan to the user for review. Thus, in some examples, the solution plan may be provided to the user without execution; while in other examples the results of the execution of the solution plan may be provided to the user without having provided the solution plan to the user for review. Additionally, the user may provide user prompts to the AI system which may include a collection of individual requests, queries and other text (e.g., a paragraph of content), where the AI system may process such complex user provided inputs to develop complete solution plans that are ready for execution by a plan creation component of the AI system, or for user review before execution.

Various technical differences and benefits are achieved by the described systems and methods. For example, the presently described systems and methods are able to generate plans dynamically, allowing for a more comprehensive solution space with greater flexibility in executing tasks. In another example, the presently described systems and methods are able to leverage the LLM's access to numerous skills and resources, including but not limited to application program interfaces to external resources (APIs) and internal resources (local APIs), databases, web searches, email, and many other resources, which provides a more comprehensive solution. In still other examples, the presently described systems and methods are able to efficiently aggregate multiple long inputs in the execution of a task, while ensuring that the prompts for executing individual steps are properly sized to avoid token and buffer limits. In yet another example, the presently described systems and methods are able to employ a working memory component in the plans created and executed by the LLM, providing for a more dynamic and adaptive solution space as the memory can grow and evolve as the LLM takes steps to execute the plan. Additionally, the presently described systems and methods are able to plan and execute control flow logic like conditionals and loops, significantly increases the capabilities regarding plan creation and execution.

The overall efficiency of generating and executing solution plans is improved by omitting unnecessary processing cycles. The omission of unnecessary processing cycles can be achieved by leveraging skills and resources available to the LLM. Use of these skills and resources may also increase the accuracy of any derived and executed solution plan since the overall available resources of the systems have extended capabilities and skills that far exceed the capabilities of other systems that do not leverage the LLM resources and skills.

In AI systems, such as LLM and ML based systems, the applicability domain refers to the range of inputs or situations in which a model is expected to perform well. The applicability domain can be influenced by factors such as the quality and quantity of data available, the complexity of the problem, the algorithms and models used by the AI system, and the level of human intervention and oversight. The applicability domain may also identify scenarios where the model's predictions are reliable and accurate, as well as scenarios where the model may struggle to deliver accurate results. Understanding the applicability domain is critical for AI practitioners and users, as it can help to identify potential risks and limitations of the model, and ensure that it is only used in scenarios where it is most effective. The presently described solution plan generation has applicability over multiple domains, including but not limited to, healthcare, manufacturing, logistics and supply chain management, energy management, and financial investments, to name a few.

In some examples, the applicability domain may include ML based systems where skills and resources of the LLM are leveraged to identify, build, and execute plans to compose technical articles, white papers, and algorithms that may aggregate resources and information to solve technical problems. These systems may leverage vast amounts of data, such as text from numerous sources such as books, technical articles, online content, statistical data, and other relevant resources, which may be leveraged to train models, generate unique articles, and generate algorithms. Skills and resources of the LLM may be tailored to solve problems in specific domains, with specific training in language proficiency, grammar rules, writing style, and domain-specific knowledge necessary to produce articles and algorithms that are tailored to a specific topic or audience. The resulting technical articles and algorithms may exhibit novel approaches, original ideas, and unique perspectives; which are specifically tailored to the specific domain.

In one example, an applicability domain may include ML systems where skills and resources of the LLM are leveraged to build and execute plans to identify trends in manufacturing and possible logistics issues for manufacturing such as in supply chain management. In this example, a goal may be to predict production time supply shortage based on historical production times and other relevant factors such as input materials, temperature, humidity, and other environmental factors. The applicability domain for this problem could be defined as the range of conditions under which the machine learning model is expected to perform accurately, and outside of which its predictions may be unreliable or incorrect. These conditions may include changes in production volatility, unexpected events such as accidents, part failures or shifts in materials. Understanding and defining the applicability domain for this problem is important to ensure that the model can be used effectively for methods of manufacturing, factory planning, and supply ordering decisions.

In another example, the applicability domain may include ML where skills and resources of the LLM may be leveraged to identify and execute patient treatment plans to predicts patient outcomes based on medical patient data and statistically modeled data. In such an example, the solutions may only be reliable for certain types of patients or medical conditions. Thus, it is important for healthcare practitioners to understand this applicability domain, as it can help them to identify which patients are most suitable for the AI system and which ones may require a different approach.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an example system that is capable of implementing aspects of the techniques and technologies presented herein.

FIG. 2 illustrates another example system that is capable of implementing aspects of the techniques and technologies presented herein.

FIG. 3 illustrates example skills and resources that can be leveraged by systems, such as described herein.

FIG. 4A is an example flow diagram for a system to dynamically generate plans that can be executed by an LLM, in accordance with various aspects described herein.

FIG. 4B is another example flow diagram for a system to dynamically generate plans that can be executed by an LLM, in accordance with various aspects described herein.

FIG. 5A is an example flow diagram for a plan creation component of an example system, in accordance with various aspects described herein.

FIG. 5B is another example flow diagram for a plan creation component of an example system, in accordance with various aspects described herein.

FIG. 6A is an example flow diagram for a plan execution component of an example system, in accordance with various aspects described herein.

FIG. 6B is another example flow diagram for a plan execution component of an example system, in accordance with aspects described herein.

FIG. 7 is a computer architecture diagram illustrating an illustrative computer hardware and software architecture for a computing system capable of implementing aspects of the techniques and technologies presented herein.

FIG. 8 is a diagram illustrating a distributed computing environment capable of implementing aspects of the techniques and technologies presented herein.

### DETAILED DESCRIPTION

Existing solutions in the field of natural language processing (NLP) and large language models (LLMs) often rely on predefined functions and plans to execute tasks to realize solutions. These predefined plans, which are often designed by experts, lead to predictability and stability of outcomes based on the queries formulated in NLP.

Some user interfaces can leverage predefined functions or plans that are invoked when a key word or key string is identified in the text stream. For example, a chatbot type of user interface may extract the keywords ‘flight’ and ‘arrival time’ in a text stream when a user enters a prompt “What time does flight 201 arrive tomorrow night?” After identifying the key words or key strings, the chatbot can then leverage functions found in predefined plans to determine flight arrival times and generate a response to the user. Such predefined plans lack flexibility, where the available functions are limited by the available plans. As such, multiple refined queries may be required to realize a desired outcome, leading to user frustration.

In contrast, the presently disclosed techniques, systems, and methods can dynamically generate solution plans for the LLM to execute, allowing for a more comprehensive solution space. An example system includes a large language model (LLM), a plan creation component, a plan working memory, and a plan execution component. The plan creation component leverages the power of the LLM to break problems into sets of discrete tasks, or solution plans, which are stored in the plan working memory. As each step of a solution plan is executed by the plan execution component, results are captured in the plan working memory so that the last executed step is captured. The working memory operates in the background of the AI system to ensure that the discrete tasks are executed, managed, and tracked until a complete solution is realized. The self-maintained working memory topology provides a solution to problems areas often encountered in conventional stateless AI system that encounter token limits in problem solving.

In some examples, a chat prompt may be engineered such that the model not only emits conversational responses that are shown to the user, but also may provide inline instructions or actions such as one or more plan steps, code, or combinations thereof. The code may be written to invoke skills associated with the LLM. The code may also call APIs or leverage other resources to provide whatever the AI requires to complete the plan (e.g., place orders for bananas with Instacart, look up the latest Manchester United scores, etc.). An agent working with the AI may then simply carry out these instructions (e.g., execute the code by calling skills). The results of code execution may be injected into the next iteration with the AI. Working memory may also be injected by the orchestrator (the user or the AI depending on the implementation), leveraging all available things (e.g., resources, skills, information, data, etc.) that are semantically relevant to the discussion at hand with the AI such as past conversation history, additional memory, and results of execution of any code/instructions that the AI had previously returned. In this example chat scenario, planning may be a human intermediated interaction with the AI. The AI may thus be considered to emit direct responses, along with additional instructions that the orchestrator (e.g., the human operator) may carry out, and whose results should be included in the next iterations of planning interactions.

When an AI system model is stateless, it means that the model does not maintain any internal state or memory between inputs. In other words, the model treats each input as independent and unrelated to any previous inputs. Stateless AI models are often used in simpler tasks that do not require context or memory, such as image classification or sentiment analysis. These stateless models are generally easier to train and more computationally efficient than stateful models, as they do not require the extensive storage or manipulation of internal states required for memory. However, stateless models can struggle with tasks that require more sophisticated understanding of the relationships between inputs with longer-term contexts. The presently disclosed techniques, systems and methods are able to leverage the power and speed of stateless AI models executing small tasks, while also providing a clever solution to the memory problem by way of the working memory.

Another problem area that is overcome by the presently disclosed techniques relates to token budgets. AI systems typically have token limits (e.g., 500 tokens, 1000 tokens, etc.). A token refers to a unit of information such as a word or phrase or part of a word. Tokenization allows the AI system to process the text efficiently, by breaking down the pieces and relating them through a variety of methods and algorithms. However, once the token limit is reached, performance may suffer a context and crucial information may be lost. The use of the plan working memory 160 as presently disclosed avoids the problem of token limits, since the solution plans are broken down into lists of smaller individually executable pieces, each piece stays within the buffer limits of the AI system without exceeding the token limit, while still being able to provide large and robust solutions with large content output. In some examples, when working memory is injected by retrieving semantically relevant information, token budgets can be managed by a variety of methods such as (a) controlling relevancy of which precise items to inject vs. all of the ones recalled, and/or (b) dynamically culling and/or compressing memory using summarization and other rewriting techniques.

Although benefits described above may include the use of stateless AI with a plan working memory system, these benefits are not limited to stateless AI systems. For example, although a large language model (LLM) may be considered stateful, they are not always designed to maintain long-term memory or context across multiple inputs. For example, the GPT-3 model has a fixed input length limit, which means it can only consider a limited amount of context at once. Additionally, large language models (LLMs) are often fine-tuned for specific tasks, which can affect their ability to maintain context or memory depending on the nature of the task. The presently disclosed techniques that employ a plan creation component to break problems into small tasks, while leveraging the plan working memory to keep track of numerous inputs and tasks, may provide additional benefits to stateful AI systems, by, expanding capabilities outside of their fined-tuned operating zone, extending their input length limit, and extending their ability to track large and dynamic contexts.

In some examples, the hierarchical planning technique may be needed even when the AI does not have limits. For example, problem solving may be considered as a multi-level “planning tree”, where each level in the planning tree may involve looking up information or carrying out tasks associated with a particular level of the tree. Subsequent levels of the planning tree may be informed by a preceding level, which may aid in generation of the next level of problem solving.

Various technical differences and benefits are achieved by the described systems and methods, compared to other conventional solutions. In one example, the presently described systems and methods are able to generate plans dynamically, allowing for a more comprehensive solution space with greater flexibility in executing tasks. In another example, the presently described systems and methods are able to leverage the LLM's access to numerous skills and resources, including but not limited to application program interfaces to external resources (APIs) and internal resources (local APIs), databases, web searches, email, and many other resources, which provides a more comprehensive solution. In still another example, the presently described systems and methods are able to efficiently aggregate multiple long inputs in the execution of a task, while ensuring that the prompts for executing individual steps are properly sized to avoid token and buffer limits. In yet another example, the presently described systems and methods are able to employ a working memory component in the plans created and executed by the LLM, providing for a more dynamic and adaptive solution space as the memory can grow and evolve as the LLM takes steps to execute the plan. Additionally, the presently described systems and methods are able to plan and execute control flow logic like conditionals and loops, significantly increases the capabilities regarding plan creation and execution.

The plans or solution plans described herein may thus be considered as workflow, which may include one or more steps, functions, commands, queries, or in many cases executable code. The code can target a domain specific language, or can be transformed into raw executable code such as python, C++, java, etc. Because the AI understands code, the AI can generate the next round of code by looking at what it did in the previous iteration.

These above described benefits and improvements are achieved by the technologies as presented in further detail below.

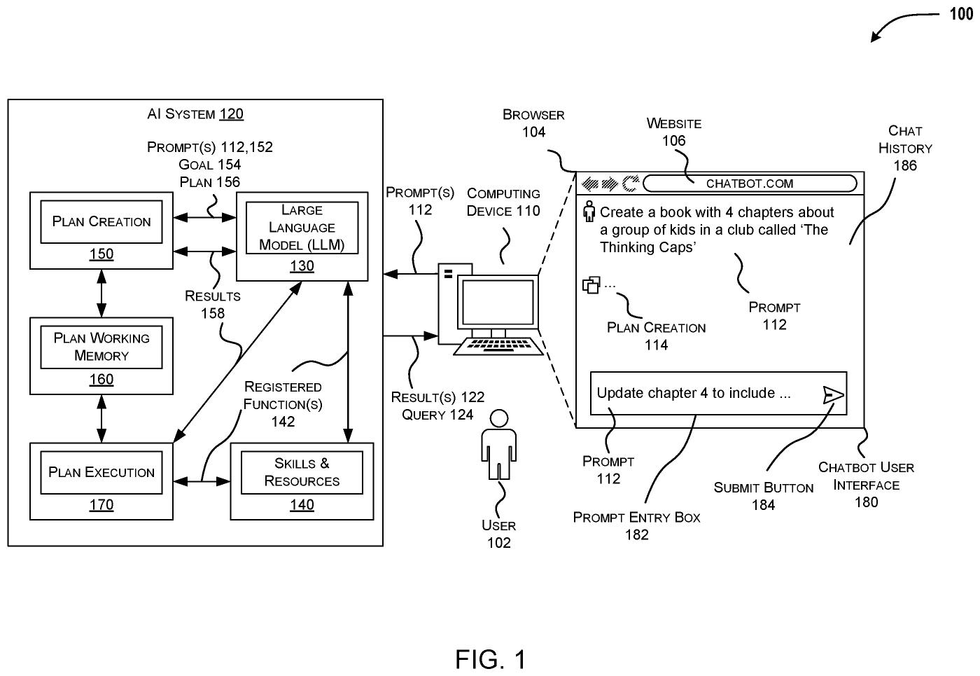

FIG. 1 illustrates an example system 100 that is capable of implementing aspects of the techniques and technologies presented herein. As illustrated, the system 100 may include an artificial intelligence (AI) system 120, that is interfaced to a user 102 via a computing device 110. The AI system 120 may include a large language model 130, skills and resources 140, a plan creation component 150, a plan working memory 160, and a plan execution component 170.

User 102 may operate computing device 110 to navigate a browser 104 to a chatbot website 106. Chatbot website 106 is one non-limiting example of an application program that may utilize a natural language model (NLM) interface to interact with users in a human-like way. The AI system 120 used by the chatbot website 106 may be located on a remote computing device, although it may alternatively be implemented by computing device 110. Thus, the logical partition between the AI system 120 and computing device 110 is merely an illustrative example, and the physical components may be implemented by either separate physical devices or combined on the same physical device(s).

A chatbot user interface 160 used by the chatbot website 106, in this example, may include a prompt entry box 162 for a user to enter a prompt 112. Clicking or otherwise selecting a trigger associated with a submit button 164 on the chatbot user interface 160 will result in prompt 112 being submitted to the AI system 120 that is used by the chatbot website 106. Chatbot user interface 160 may also include a history 166 of prior submitted prompts 112 and any prior result 202 or query 203 received from the AI system 120 responsive to a prior submitted prompt 112. In some instances, after a prompt 112 is submitted to the chatbot user interface 160, an icon or graphic element may be shown (e.g., blinking ellipses, an hourglass, spinning wheel, etc.) in the history area of the display to indicate that the submitted prompt is under review such as when a plan creation 114 is underway.

After an initial prompt 112 is submitted to the AI system 120 via the chatbot user interface 180, the AI based engine 120 processes the prompt to capture the semantic meaning of the words or phrases in the prompt so that the information is in a form to be processed by the LLM. This process, which may be referred to as embedding vectors, may include extraction of words from the prompt, and encoding the words as a sequence of embedding vectors, one for each word. The embedding vectors can then be used as input features for various NLP tasks by the LLM, such as sentiment analysis or text classification, or other meaningful insights from the text data.

The AI system 120 may use various natural language processing (NLP) techniques to determine context around keywords and phrases in the text data. One techniques, called contextual word embeddings, represents each word found in a text prompt as a dense, low-dimensional vector that captures meaning in the context of the surrounding words by applying deep learning models. The LLM 130 in the present AI system 120 can be trained on large amounts of text data to learn the patterns and relationships between words and phrases in different contexts. When processing a piece of text data, words and phrases can be context related to their closely related target keyword or phrase in their embeddings by the LLM 130.

For example, suppose the AI system 120 needs to process the prompt “What time does my flight arrive tomorrow night?” The AI system 120 may first tokenize the sentence into individual words, transforming them into a format used by the machine learning model of the LLM 130, which then generates contextual word embeddings for each word in the sentence with identification of target keywords. Some target keywords may include, ‘flight’, ‘arrive’, and ‘tomorrow’; which are most closely related to the phrases “flight arrival time” and the contextual timeframe of “tomorrow night.” The LLM can then use the identified keywords and their surrounding context to generate a response to the prompt, such as “Your flight is scheduled to arrive at 10:30 PM tomorrow night.” In sum, the LLM 130 is able to accurately identify the meaning of the sentence and generate a relevant response using contextual word embeddings and other NLP techniques to understand the context around the keywords and phrases in the prompts.

For the present AI system 120, the prompt 112 may either be sent directly to the plan creation component 150 or received from LLM 130. For instances where the plan creation component receives the prompt 112 from the computing device 110, the plan creation component may leverage the LLM 130 to determine a context for the prompt 112, as well as identify one or more of a goal 154, a solution plan 156, and other limitations or conditions of a solution plan. For instances where the LLM 130 receives the prompt 112 from the computing device 110, the LLM 130 may determine a context for the prompt 112, before sending one or more of the prompt 112, the goal 154, the solution plan 156, and other limitation or conditions of the solution plan to the plan creation component 150.

The plan creation component 150 may leverage the LLM 130 to analyze context and determine if additional skills and resources 140 are required to prepare a response to the user 102. The LLM 130 is aware of the additional skills and resources 140 by a registration process, where any of the skills and resources available to the LLM 130 may be leveraged in formulating a response. The skills and resources 140 may be numerous, including but not limited to registered functions, application program interfaces to external resources (APIs) and internal resources (local APIs), databases, web searches, email, and many other resources.

Additionally, the LLM may be leveraged to identify a goal 154 for a problem to be solved, which may then be submitted to the plan creation component 150. The plan creation component 150 may process the goal and devise a solution plan 154. In otherwords, a new solution plan 154 may be formulated by the plan creation component 150 to solve the newly identified goal from the LLM 130. As described herein, the new solution plan 154 may include access to any registered functions or other resources of the LLM 130, as well be able to execute control flow logic such as conditionals and loops as part of the solution plan 156. Since the solution plans 156 are dynamic, or changing, based on the prompts 112, static plans need not be adhered to, providing improved functionality and problem solving.

As described above, the plan creation component 150 may be generally described as a software component that receives a prompt 112, identifies a goal 154, and processes the goal 154 to build a solution plan 156. When the plan creation component 150 processes the goal 154, the problem to be solved for the goal 154 is broken down into a series of processing steps, as well as conditional loops thereof, which may leverage any or all possible functions, skills, and resources available to the LLM 130. Additionally, the plan creation component 150 may leverage additional prompts 152 and responses to/from the LLM 130 itself in building a solution plan 156. The resulting solution plan 156, along with the goal 154 and all related context information (e.g., embeddings, prompts, etc.), are stored in the plan working memory 160. It is important to note that, in some instances, the plan creation component 150 may also receive a solution plan 154 and or set of conditions and/or limitations for a solution plan as part of the prompt 112. The solution plan 156 may also be provided to the computing device 110 directly, or to the LLM 130 to apply NLM processes to prepare the solution plan before being sent to the user 102 via the computing device 110 and the chatbot user interface 160.

The plan execution component 170 may generally be described as the software component that receives the goal 154, the solution plan 156, and all related context information from the plan working memory 160, and processes the solution plan 156 to generate the resulting solution. Each step of the solution plan 156 is executed, leveraging registered functions, skills and resources of the LLM 130, and all results are used to update the content and context of the plan working memory 160 until a completed solution for the goal 154 is reached. After the completed solution for the goal is reached, the result or result(s) 158 may either be provided to the computing device 110 directly, or provided to the LLM 130 to apply NLM processes to prepare the final results before being sent to the user 102 via the computing device 110 and the chatbot user interface 160.

Although the above description illustrates a text based user interface, this is merely one non-limiting example, and the specific implementation of the user interface may be text based, graphically based, voice based, or any combination thereof, without departing from the spirit of the present disclosure.

The solution space that can be explored by the plan creation component 150 may be quite broad, given the access to all registered functions 142, skills and resources 140 of the LLM 130. Additionally, the plan creation component 150 has extreme flexibility in formulating a procedure for the solution plan 156, which may include all varieties of logic and flow controls such as loops and conditions. Thus, the overall solution plan 156 is dynamic and extremely flexible in design, and provides a more comprehensive solution then conventional systems. Given the deep execution control that can be provided in solution plans that are achieved, the plan creation component 150 may enable efficient aggregation of multiple long inputs in the execution of tasks required to achieve the goal 154. Moreover, the plan working memory 160 need not be fixed in size, and can be dynamically allocated as needed to accommodate the building of the plan by the plan creation component 150, as well as by the execution and results generated by the plan execution component 170. Thus, a more dynamic and adaptive solution space is achieved since the plan working memory 160 can grow and evolve as needed to execute the solution plan 156.

In some examples, the planning stage can be guided by feedback from users or other AI components or systems. Planning can include explicit steps such as to query the user, or alternatively to a discriminator AI, “what do you think so far?” and/or “are we going in the correct direction with the plan so far?” and/or “Does this plan seem to be what you had in mind?” The discriminator AI may comprise the same LLM, but with a different set of prompts that urge the LLM to play the role of a critic, for example. The feedback may then be included in the working memory (or context) that can be sent to the AI.

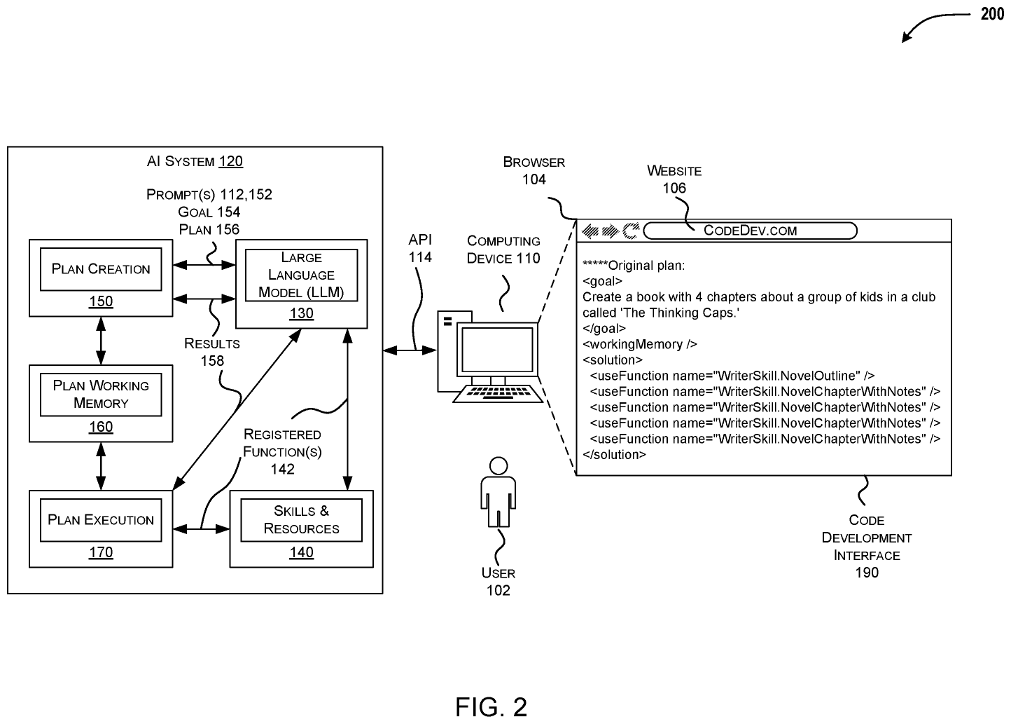

FIG. 2 illustrates another example system 200 that is capable of implementing aspects of the techniques and technologies presented herein.

Similar to system 100 of FIG. 1, system 200 may include an artificial intelligence (AI) system 120, that is interfaced to a user 102 via a computing device 110. The AI system 120 may again include a large language model (LLM) 130, skills and resources 140, a plan creation component 150, a plan working memory 160, and a plan execution component 170. System 200 is substantially similar to system 100, and thus similarly labeled components will operate as previously described above.

For system 200, user 102 may operate computing device 110 to navigate a browser 104 to a code development website 106, where a code development interface 190 may be accessed. Through this code development interface 190, application program interfaces (APIs) such as API 114 may be used to access the artificial intelligence (AI) system 120. In one example, a goal may be directly defined by the user in the code development interface. In another examples, the skills and resources 140 may be specified by the user 102 for the desired solution. For example:

```
<goal>
  Create a book with 4 chapters about a group of kids in a club called ‘The Thinking
  Caps.’
</goal>
<WorkingMemory />
<solution>
  <useFunction name=″WriterSkill.NovelOutline″ />
  <useFunction name=″WriterSkill.NovelChapterWithNotes″ />
  <useFunction name=″WriterSkill.NovelChapterWithNotes″ />
  <useFunction name=″WriterSkill.NovelChapterWithNotes″ />
  <useFunction name=″WriterSkill.NovelChapterWithNotes″ />
</solution>
```

For the above example, the goal is not generated in response to a prompt 112, as it would be for system 100, but instead the goal may be directly specified by the user 102 and provided to the AI based engine 120 through API 114. Also illustrated above, the specific functions of the desired solution may be specified and provided to the AI system 120 through API 114.

The implementation example of FIG. 2 illustrates how a user might manually define a goal or require specific functions in the desired solution. These manual definitions are illustrative only, and additional examples are contemplated. For example, manual definitions may be used to define any combination of a prompt, a goal, excluded functions, included functions, limitations and/or conditions of a solution plan, or even a complete solution plan.

The described manual definitions may be provided to the plan creation component 150 by an API call 114. In some examples, the API calls 114 may be provided as XML, JSON, or any other format that may encapsulate the manual definitions for presentation to the plan creation component 150. Once the manual definitions are received by the plan creation component 150, the plan creation component 150 will follow a similar process to that previously described for system 100 of FIG. 1, with the manual definitions either replacing or supplementing the corresponding definitions that are generated and stored in the plan working memory 160.

The plan execution component 170 of FIG. 2 may also be accessed via an API call 114. When API 114 is utilized to access the plan execution component 170, the solution plan that is in the plan working memory is executed as a sequence of steps to provide the complete solution similar to that already described previously. However, in this instance, the context of the solution plan may have been amended, revised or replaced by various manual definitions that were previously presented to the plan creation component 150 and stored in the plan working memory 160.

Although FIG. 2 illustrates a code development interface 190 that is accessed by a website 106 in a browser 104, this is merely one non-limiting example, and other examples are contemplated within the spirit of the present disclosure. In some examples, code development may be accessed via an application program that is locally installed on computing device 110, which may access the AI based engine 120 via one or more APIs 114. In some other examples, an application program running on computing device 110 may simply access the AI based engine 120 via one or more APIs 114.

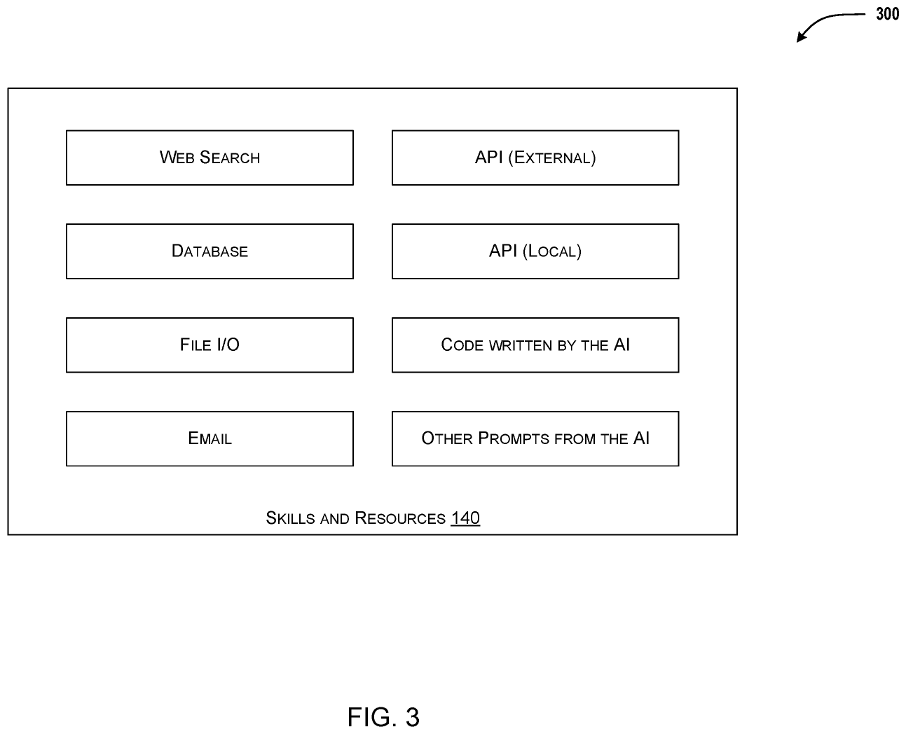

FIG. 3 illustrates example skills and resources 300 that can be leveraged by a large language model (LLM) based system, such as described herein. For example, the AI based engine 120 in FIGS. 1 and 2 may include an LLM 130 that has registered skills and resources 140, which may correspond to any of the skills and resources illustrated in FIG. 3. As illustrated the skills and resources may include any variety of web search, database, file input/output (I/O), external or internal APIs, code written by the AI based engine 120 or other prompts from the AI based engine 120.

Example web search skills and resources may include leveraging browser based search engine resources (e.g., Microsoft Bing, Google Search, Yahoo! Search, Baidu, etc.) to identify content that may be relevant to the goal and solution plan. Example database skills may include access to any variety of database including, but not limited to online databases (e.g., Wikipedia, DBpedia, Freebase, Wikidata, etc.), question-answer databases (e.g., Quora, Stack Overflow, Chegg, Yahoo! Answers, etc.), text corpora databases (e.g., Common Crawl, OpenWeb Text, etc.) as well as domain-specific databases (e.g., medical, legal, financial, scientific, engineering, geographic, social media, etc.). Examples of file I/O may include access to locally stored files or remotely stored files (e.g., Dropbox, Google Drive, iCloud, Microsoft One Drive, Box, etc.). Examples of email may include access to web-based email tools (e.g., Google Gmail, Yahoo! Mail, Outlook.com from Microsoft, etc.). Examples of external APIs may include APIs to access social media (e.g., Facebook, Twitter, Instagram), payment processing (e.g., PayPal, Stripe, etc.), weather (e.g., OpenWeatherMap, Weather Underground, etc.), mapping (e.g., Google Maps, Mapbox, etc.), or news (e.g., New York Times, Bloomberg, etc.), to name a few. Examples of local APIs may include APIs to access local OS functions such as for the local computer file system, process management, network, user interface, graphics, audio/video, and security, to name a few. Code written by the AI may include any variety of source code including, but not limited to, pseudocode, code snippets, programs, and algorithms in a variety of languages, such as, Python, Java/JavaScript, C/C++, Ruby, PHP, SQL, Swift, React, Angular, Django, Rust, HTML/CSS, XML, to name a few.

The above described embodiments of FIGS. 1-3 correspond to examples of AI systems with large language models (LLM) that are configured to operate as a planner. The term “planner” may thus be used to describe the overall process of prompting the AI system 120, creating a solution plan, iterating over the solution plan, and executing the solution plan to achieve an output. Various different implementations may employ the topology described above, are considering within the scope of the present disclosure, and may also be referred to as a planner or planner application.

When a planner is invoked in an AI system, the objective is to generate a solution plan and a solution that is meaningful to the user. However, the AI system may not always achieve this objective. One important benefit of the disclosed AI system is that the planner can be guided by presenting the AI system with positive and negative examples. or “feedback.” For example, when the plan creation component 150 is initially invoked to generate a new plan for a goal, the resulting solution plan may be mismatched with respect to the intended goal of the user. Positive and/or negative feedback may be provided by the user to the AI system 120 to guide the improvement of the presented solution plan. The feedback to the AI system 120 may be provided either explicitly or implicitly, in both positive and negative forms. In one example, after a user is presented a proposed solution plan, the user can optionally provide explicit feedback to the AI system 120 by stating “the plan is good” or “the plan is not good.” In another example, after a user is presented a proposed solution plan, the user can optionally provide implicit feedback to the AI system 120 by cancelling, starting over, or expressing a lack of satisfaction with non-obvious actions. The feedback from the user is collected by the AI system 120 as examples, including whether the examples are implicit or explicit, and noting how often the examples occur. The examples can also be semantically indexed using embeddings, to enable similarity comparisons. For instance, a good plan about how to plan a wedding can be reused as a good example when the user is planning a party. Bad examples about how not to prepare for an interview, can be used as bad examples when the user is preparing for a presentation. This described approach may be used to improve the AI system overtime, through usage and feedback, tailoring plan creation to individual user preferences, and improving plan efficiency through crowdsourcing the AI system.

In some instances, the planner may encounter a scenario where a complete solution plan for a goal cannot be realized. These incomplete solutions can be addressed in varying contexts, such as, by a user or by a skills developer.

To address examples where a user cannot find a complete solution, the planner can be tailored to provide a prompt to the user asking to “learn a new skill”. The user may then provide an ad hoc explanation to guide the AI in developing a skill. For example, the user may list basic steps to complete the task, and/or explain how to accomplish the new task. The AI system 120 can then save and add the new skill to the available skills and resources 140, which can then be leveraged for future use. When the AI system 120 is asked again to create a similar plan, the plan creation component 150 can leverage the new skill without prompting the user.

To address examples where a skills developer cannot find a complete solution, the planner can be tailored to inform the skills developer that some skills are missing. For example, the plan creation component may provide a response such as “unable to achieve”, which may be used to indicate an area of investment. For instance, if the planner is unable to query Bing Marketplace or book a place on AirBnb, a developer could use this information as an opportunity to develop and share such a new skill. The new skill can then be added to the available skills and resources 140, which can then be leveraged for future use by others.

In some examples, the planner can be tailored to automatically discover missing skills through a self-discovery process. For example, the AI system may be configured to leverage the LLM to generate random goals that are focused on a given domain, identify and collect missing skills, and add the new skills to the available skills and resources 140, which can then be leveraged for future use by others. In this way, the ability of the planner to create plans in a specific domains may be improved.

Skills that are learned by the AI system may also be comprised of plans. As described previously, plans or solution plans may be considered as a workflow, which may include one or more steps, scripts, functions, commands, queries, or in many cases executable code. An example missing skill may be developed by the AI system, either autonomously or guided by other AI systems or users, as a script including one or more steps. Each of the one or more steps may include other existing skills, functions, commands, queries, code generation, code execution, or even other scripts. Once the plan is developed for the new skill, all of the steps taken to achieve the goal of the plan can be collectively saved as the new skill.

In addition to learning new skills, existing skills may be found to be ineffective in lieu of learnings of the AI system, may be amended, revised, updated, or deprecated to reflect learnings from the AI system. In such an example, the “old skill” may be effectively “unlearned”, or replaced by the new skill.

In various examples described herein, the user may not even be aware that the AI system is learning new skills or even that a solution plan is being developed. For example, a user may be participating in an interactive discussion with an AI system (e.g., posing queries via a chatbot interface), where the AI system may be required to solve one or more new problems to satisfy queries from the user. In this instance, a solution plan may be internally developed by the AI system to satisfy the user query without the user having specific knowledge of the solution plan. The AI system may thus autonomously develop solution plans, and save or register those skills that are developed so that future queries may be processed quicker.

In some examples, multiple inputs may collectively (e.g., in paragraph form) be provided by a user to the plan creation component of the AI system, which responsively generates a solution plan that is ready for execution by a plan execution component. Thus, when a user inputs a detailed paragraph of text to the AI system, the plan creation component of the AI system can process the text, accessing all relevant functions, skills and resources, and generate a complete solution plan that is ready for execution by the plan execution component. Once the plan execution component is instructed to execute the solution plan, all of the skills and resources are directly access, meaning the plan is in motion and all executable components are processed to generate content for the user.

Although the above descriptions of the systems for FIGS. 1-4 illustrate a planner process that develops a single solution plan, the present disclosure is not so limited. In some implementations, the described system with planner processes may instead develop multiple plans which may be operated on concurrently (e.g., by the plan execution component of the AI system 120, which may be configured for parallel processing). For example, the planner may be tailored to generate multiple solution plans to achieve the given goal, and then execute all the solution plans in parallel. This concurrent operation may be accomplished in a couple of ways. In one example, multiple solution plans are executed in parallel, and execution of all solution plans by the planner is terminated as soon as a single solution to the problem is found by any one execution. In another example, multiple solution plans are executed in parallel with a constraint/budget (e.g., cost, duration, etc.), and execution is terminated when either all solutions are achieved or the execution exceeds the constraint/budget.

The plan working memory 160 described previously above may be used by the AI system 120 as a stateful representation of the solution plan. The solution plan generated by the planner is a very detailed script that contains the entire initial state of the solution, and the entire state of the solution after each step is executed. At each step of execution, the solution plan can be expressed as a document that represents a snapshot of the current state of execution. This implementation and representation may also be accessible to the user to enable the user to step backwards and take a different execution path. For instance, given a solution plan consisting of 10 steps, users might decide to stop the execution after step 7, go back to step 3, edit the solution plan, and restore the execution with the changes applied, proceeding from step 3. This technique may be referred to as “backtracking.”

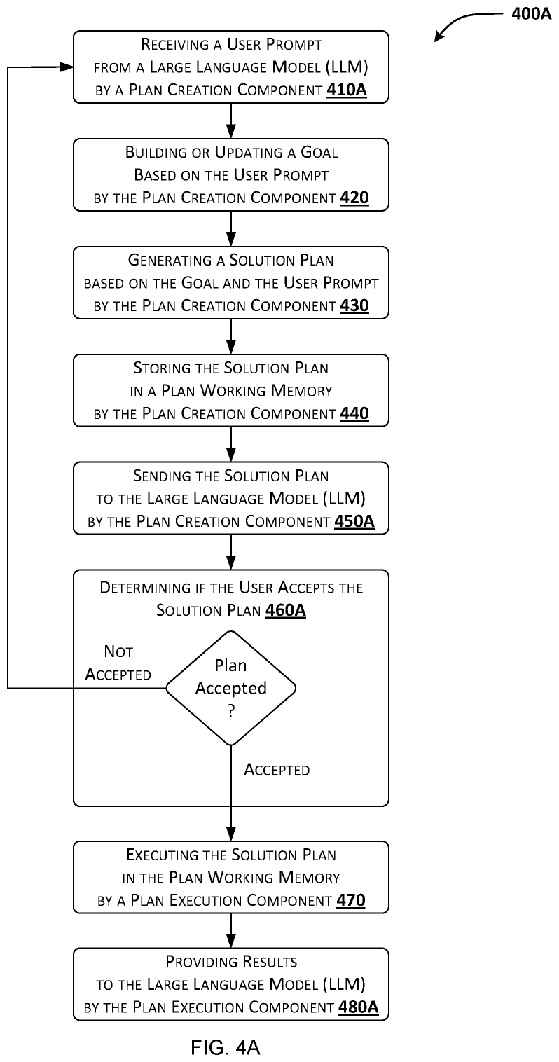

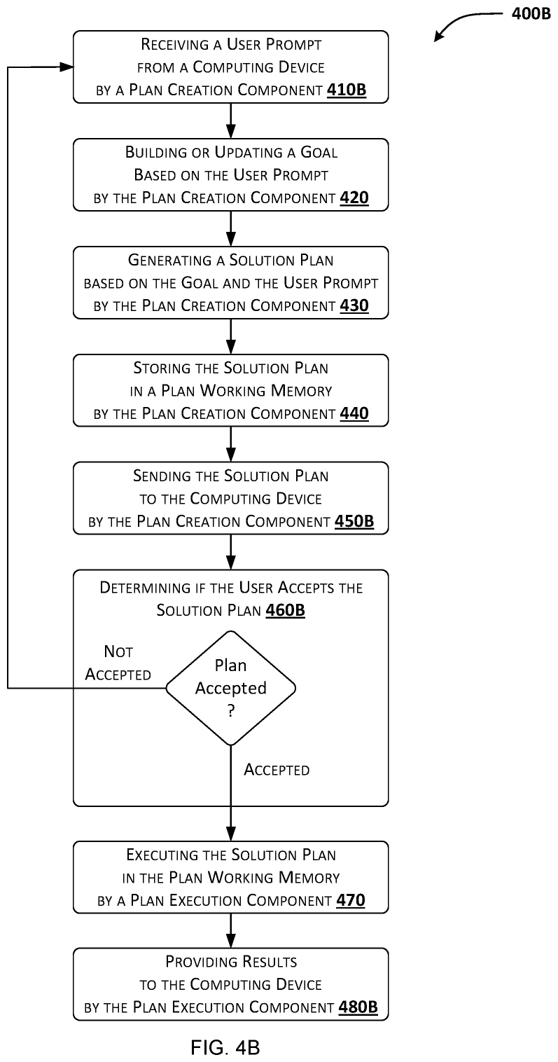

The above described features may be implemented in multiple ways, including the flow charted illustrations of FIGS. 4A-6B described below, which are considered non-limiting examples.

FIG. 4A is an example flow diagram 400A for a system (e.g., 100, 200, etc.) to dynamically generate plans that can be executed by an LLM, arranged in accordance with various aspects described herein. The flow diagram 400A may be broken into various blocks or partitions, such as blocks 410A, 420, 430A, 440, 450A, 460A, 470 and 480A, as illustrated. In this example, an interactive interface such as an NLP interface, may be used for all input and output to the AI based engine 120 and the corresponding LLM 130, plan creation component 150, plan working memory 160, and plan execution component 170, such as described previously with respect to FIG. 1. Processing for the various blocks of flow diagram 400A, which may be described as processes, methods, steps, or functions, may commence at block 410A.

At block 410A, “Receiving a User Prompt from a Large Language Model (LLM) by a Plan Creation Component”, a prompt from a user (e.g., 112) may be received by a large language mode (e.g., 130) and sent to the plan creation component (e.g., 150) for processing. The user prompt may correspond to a single natural language string or sentence that presents one or more of a question, an instruction, an example, or data. In other examples, the user prompt may include cascaded sets of strings or sentences. In still other examples, the user prompt may include a combination of question, instruction, example and/or data that may be helpful in performing a task. In yet further examples, the user prompt may include details about stylistic choices for images, writing, or presentation of results. The user prompt is recognized by the LLM (e.g., 120) as requiring plan creation and is passed to the plan creation component (e.g., 150) for further processing. Block 410A may be followed by block 420.

At block 420, “Building or Updating a Goal Based on the User Prompt by the Plan Creation Component”, a goal may be created by the plan creation component (e.g., 150) based on the received user prompt (e.g., 112). The user prompts may be provided in any form, from simple to complex. An example simple prompt may be a single question in a short phrase or sentence. An example complex prompt may be either multiple phrases or sentences combined together or in succession to one another. In still other examples, the user prompt may include manual definitions embedded therein such as previously described. After the plan creation component (e.g., 150) receives the user prompt, whether simple or complex, the plan creation component may leverage a large language mode (e.g., 130) to analyze and determine the semantic meaning of the phrases and identify a goal (e.g., 154). If a prior goal exists within the determined semantic meaning of a successively received prompt, the plan creation component (e.g., 150) may update, revise, or replace the goal. Block 420 may be followed by block 430.

At block 430, “Generating a Solution Plan based on the Goal and the User Prompt by the Plan Creation Component”, a solution plan (e.g., 156) may be generated based on the goal (e.g., 154) and the user prompt (112). The solution plan may include any number of steps to be executed. Some steps of the solution plan may employ a function, skill, or resource from any that are available to the LLM (e.g., registered functions, registered skills, and registered resources, etc.). Various steps may also include logical flow and/or decision making conditions, and/or loops as previously described. Also, steps of the solution plan may employ prompts that may be provided to the LLM (e.g., 120) during execution to gather additional details and content. In some examples, certain steps may be defined or embedded in the user prompt, where specific functions may be excluded or included based manual definitions as previously described. Block 430 may be followed by block 440.

At block 440, “Storing the Solution Plan in a Plan Working Memory by the Plan Creation Component”, the solution plan (e.g., 156) that is generated by the plan creation component (e.g., 150) is stored in the plan working memory, such as plan working memory 160 of FIG. 1. The solution plan in the plan working memory is also contextually connected to the goal (e.g., 154) and user prompts (e.g., 112) that were used to generate the solution plan. Block 440 may be followed by block 450A.

At block 450A, “Sending the Solution Plan to the Large Language model (LLM) by the Plan Creation Component”, the solution plan (e.g., 156) that was generated by the plan creation component (e.g., 150) may be passed to the large language mode (e.g., 130) for further processing. The large language mode (LLM) may then process the solution plan using NLP, which may then be communicated to the computing device (e.g., 110) of the user (e.g., 102) for review. In some examples, one or more of the solution plan and the goal may be provided to the user by sending a message (e.g., by the LLM) to the user (e.g., 102) of the computing device (e.g., 110). Block 450A may be followed by block 460A.

At block 460A, “Determining if the User Accepts the Solution Plan”, the solution plan may be reviewed for acceptance by the user (e.g., 102). For example, the user may review the proposed solution plan (e.g., 156) as presented by a user interface (e.g., chatbot user interface 180). If the user does not accept the proposed solution plan, then processing continues from block 460A to block 410A, where the user may send additional prompts to refine, update or replace the user prompt, goal and/or solution plan via NLP, which may be processed by the LLM. The refined user prompt may include or embed manual definitions as previously described. If the user does accept the proposed solution plan, then processing continues from block 460A to block 470.

At block 470, “Executing the Solution Plan in the Plan Working Memory by a Plan Execution Component”, the steps in the solution plan (e.g., 154) in the plan working memory (e.g., 160) are executed by the plan execution component, such as plan execution component 170 of FIG. 1. The execution may include execution of functions, skills, or access to resources, as well as program control flow logic as previously described. Additionally, some steps when executed may provide additional prompts to the LLM (e.g., 120). In some examples, the execution of the solution plan may be initiated by a key phrase that may be received from the user in a prompt to the LLM, such as “Execute Solution Plan.” In other examples, an API call may be employed to initiate the execution of the solution plan. In still other examples, the execution of the solution plan may be automatically initiated based on some other condition being satisfied (e.g., execution at a predefined time based on the original prompt, etc.). Upon completion of the execution of the steps of the solution plan, processing may continue from block 470 to block 480A.

At block 480A, “Providing Results to the Large Language Model (LLM) by the Plan Execution Component”, the results from the executed steps in the solution plan (e.g., 156) are provided to the large language model (LLM), such as LLM 130 in FIG. 1. In some examples, the LLM may prepare a message to the user 102 for receipt at a user interface (e.g., chatbot user interface 180) so that the user 102 may review the detailed results of executed solution plan. In other examples, the solution plan may be stored or saved as a new skill (or revised skill) for the LLM.

FIG. 4B is another example flow diagram 400B for a system (e.g., 100, 200, etc.) to dynamically generate plans that can be executed by an LLM, arranged in accordance with various aspects described herein. The flow diagram 400B may be broken into various blocks or partitions, such as blocks 410B, 420, 430, 440, 450B, 460B, 470 and 480B, as illustrated. In this example, an API based interface may be used for all input and output to the AI based engine 120 and the corresponding LLM 130, plan creation component 150, plan working memory 160, and plan execution component 170, such as described previously with respect to FIG. 2. Processing for the various blocks of flow diagram 400B, which may be described as processes, methods, steps, or functions, may commence at block 410B.

At block 410B, “Receiving a User Prompt from Computing Device by a Plan Creation Component”, a prompt from a user (e.g., 112) may be received by the plan creation component (e.g., 150) for processing. The user prompt may again correspond to a single natural language string or sentence that presents one or more of a question, an instruction, an example, or data. In other examples, the user prompt may include cascaded sets of strings or sentences. In still other examples, the user prompt may include a combination of question, instruction, example and/or data that may be helpful in performing a task. In yet further examples, the user prompt may include details about stylistic choices for images, writing, or presentation of results Block 410B may be followed by block 420.

At block 420, “Building or Updating a Goal Based on the User Prompt by the Plan Creation Component”, a goal may be created by the plan creation component (e.g., 150) based on the received user prompt (e.g., 112). The user prompts may be provided in any form, from simple to complex, which may also correspond to paragraphs of content including queries and other information. An example simple prompt may be a single question in a short phrase or sentence. An example complex prompt may be either multiple phrases or sentences combined together or in succession to one another. In still other examples, the user prompt may include manual definitions embedded therein such as previously described. After the plan creation component (e.g., 150) receives the user prompt, whether simple or complex, the plan creation component may leverage a large language mode (e.g., 130) to analyze and determine the semantic meaning of the phrases and identify a goal (e.g., 154). If a prior goal exists within the determined semantic meaning of a successively received prompt, the plan creation component (e.g., 150) may update, revise, or replace the goal. Block 420 may be followed by block 430.

At block 430, “Generating a Solution Plan based on the Goal and the User Prompt by the Plan Creation Component”, a solution plan (e.g., 156) may be generated based on the goal (e.g., 154) and the user prompt (112). The solution plan may include any number of steps to be executed. Some steps of the solution plan may employ a function, skill, or resource from any that are available to the LLM (e.g., registered functions, registered skills, and registered resources, etc.). Various steps may also include logical flow and/or decision making conditions, and/or loops as previously described. Also, steps of the solution plan may employ prompts that may be provided to the LLM (e.g., 120) during execution to gather additional details and content. In some examples, certain steps may be defined or embedded in the user prompt, where specific functions may be excluded or included based manual definitions as previously described. Block 430 may be followed by block 440. In some examples, the solution plan may be provided in a ready to be executed form for a plan execution component,

At block 440, “Storing the Solution Plan in a Plan Working Memory by the Plan Creation Component”, the solution plan (e.g., 156) that is generated by the plan creation component (e.g., 150) is stored in the plan working memory, such as plan working memory 160 of FIG. 2. The solution plan in the plan working memory is also contextually connected to the goal (e.g., 154) and user prompts (e.g., 112) that were used to generate the solution plan. Block 440 may be followed by block 450B.

At block 450B, “Sending the Solution Plan to the Computing Device by the Plan Creation Component”, the solution plan (e.g., 154) may be sent to the computing device (e.g., 110) by the plan creation component (e.g., 150) via an application program interface (API), such as API 114 of FIG. 2. Block 450B may be followed by block 460B.

At block 460B, “Determining if the User Accepts the Solution Plan”, the solution plan may be reviewed for acceptance by the user (e.g., 102). For example, an application program or code development interface (e.g., 190) may be used by the user (e.g., 102) to review the proposed solution plan (e.g., 156). If the user does not accept the proposed solution plan, then processing continues from block 460B to block 410B, where the user may initiate additional API calls to send additional prompts to refine, update or replace the user prompt, goal and/or solution plan, which may be processed by the plan creation component 150. The refined user prompt may include or embed manual definitions as previously described. If the user does accept the proposed solution plan, then processing continues from block 460B to block 470.

At block 470, “Executing the Solution Plan in the Plan Working Memory by a Plan Execution Component”, the steps in the solution plan (e.g., 156) in the plan working memory are executed by the plan execution component, such as plan execution component 170 of FIG. 2. The execution may include execution of functions, skills, or access to resources, as well as program control flow logic as previously described. Additionally, some steps when executed may provide additional prompts to the LLM (e.g., 120). In some examples, the execution of the solution plan may be initiated by a key phrase that may be received from the user in a prompt to the LLM, such as “Execute Solution Plan.” In other examples, an API call may be employed to initiate the execution of the solution plan. In still other examples, the execution of the solution plan may be automatically initiated based on some other condition being satisfied (e.g., execution at a predefined time based on the original prompt, etc.). Upon completion of the execution of the steps of the solution plan, processing may continue from block 470 to block 480B.

At block 480B, “Providing Results to the Computing Device by the Plan Execution Component”, the results from the executed steps in the solution plan (e.g., 156) are provided to the computing device via an application program interface (API), such via an API 114. In some examples, an application program or code development interface (e.g., 190) may be used by the user (e.g., 102) to review the detailed results of executed solution plan. In other examples, the solution plan may be stored or saved as a new skill (or update an existing skill) for the LLM.

The example user interaction illustrated below demonstrates how natural language may be employed to provide prompts to create and revise an example solution plan:

```
> dotnet run createplan “Find the latest news headlines and write a funny poem about it.”
  <goal>
      Find the latest news headlines and write a funny poem about it.
  </goal>
  <plan>
    <function.bing.SearchAsync input=“latest news headlines”
        setContextVariable=“SEARCH_RESULT” />
    <function._GLOBAL_FUNCTIONS_.BucketOutputs
        input=“$SEARCH_RESULT”
        bucketCount=“3” bucketLabelPrefix=“HEADLINE” />
    <function.WriterSkill.funce0b2aafaf46c4761bb7d0cb34e0402f7
        input=“$HEADLINE_1; $HEADLINE_2; $HEADLINE_3”
        appendToResult=“RESULT_{——}POEM” />
  </plan>
Note:
in some additional examples, these functions can be managed as code running in a runtime environment, using variables and, set/get statements.
```

User reviews the plan and does not like that three headlines are passed to WriterSkill.
User revises the ask using natural language and runs createplan again.

```
> dotnet run createplan “Find the latest news headlines and write a funny poem about each
of them.”
  <goal>
    Find the latest news headlines and write a funny poem about each of them.
  </goal>
  <plan>
    <function.bing.SearchAsync input=“latest news headlines”
      appendToResult=“RESULT_{——}HEADLINES” />
    <function._GLOBAL_{——}FUNCTIONS_.BucketOutputs
      input=“$RESULT_HEADLINES” bucketCount=“3”
      bucketLabelPrefix=“Headline” />
    <function.WriterSkill.funcc033d61295e140d0b9713523add0f1a9
      input=“$Headline_1” appendToResult=“RESULT_POEM_1” />
    <function.WriterSkill.funcc033d61295e140d0b9713523add0f1a9
      input=“$Headline_2” appendToResult=“RESULT_POEM_2” />
    <function.WriterSkill.funcc033d61295e140d0b9713523add0f1a9
      input=“$Headline_3” appendToResult=“RESULT_{——}POEM_3” />
  </plan>
```

Success, the user is confident the provided plan will generate three different poems about each of the headlines the Bing skill Search function returns.
User is now ready to Execute the plan.
>dotnet run executeplan “Find the latest news headlines and write a funny poem about each of them.”
User is presented a poem that is written according to the solution plan.

Another example user interaction illustrated below demonstrates how manual modifications may be employed to provide prompts to create and revise an example solution plan:

```
> dotnet run createplan “Find news about technology and write a funny poem about it.”
  <goal>
    Find news about technology and write a funny poem about it.
  </goal>
  <plan>
    <function.bing.SearchAsync input=“technology news”
      setContextVariable=“SEARCH_RESULT” />
    <function._GLOBAL_FUNCTIONS_.BucketOutputs
      input=“$SEARCH_RESULT” bucketCount=“3”
      bucketLabelPrefix=“NEWS” />
    <function.WriterSkill.ShortPoem input=“$NEWS_1; $NEWS_2; $NEWS_3”
      appendToResult=“RESULT_{——}POEM” />
  </plan>
```

The user does not like that the plan uses ShortPoem, and that it uses 3 headlines.
The user manually modifies the new plan to use LongPoem, and adjusts the limit to 2 headlines

```
<goal>
  Find news about technology and write a funny poem about it.
</goal>
<plan>
  <function.bing.SearchAsync input=“technology news”
    setContextVariable=“SEARCH_RESULT” />
  <function._GLOBAL_FUNCTIONS_.BucketOutputs
    input=“$SEARCH_RESULT” bucketCount=“3”
    bucketLabelPrefix=“NEWS” />
  <function.WriterSkill.LongPoem input=“$NEWS_1; $NEWS_2”
    appendToResult=“RESULT_{——}POEM” />
</plan>
```

Success, the user is confident the manually adjusted plan will generate a long poem about each of the 2 headlines the Bing skill Search function returns.
User is now ready to Execute the plan.
>dotnet run executeplan “Find news about technology and write a funny poem about it.”
User is presented a poem that is written according to the solution plan.

Although the above described example is for authorship of a poem, this is merely one examples and numerous other examples of authorship in technical areas are also possible. In light of the present disclosure, it is understood that solution plan generation and execution of those solution plans have applicability over multiple domains in multiple technical fields, including but not limited to, healthcare, manufacturing, logistics and supply chain management, energy management, and financial investments, to name a few.

In some examples, the applicability domain may include ML based systems where skills and resources of the LLM are leveraged to identify, build, and execute plans to compose technical articles, white papers, and algorithms that may aggregate resources and information to solve technical problems. These systems may leverage vast amounts of data, such as text from numerous sources such as books, technical articles, online content, statistical data, and other relevant resources, which may be leveraged to train models, generate unique articles, and generate algorithms. Skills and resources of the LLM may be tailored to solve problems in specific domains, with specific training in language proficiency, grammar rules, writing style, and domain-specific knowledge necessary to produce articles and algorithms that are tailored to a specific topic or audience. The resulting technical articles and algorithms may exhibit novel approaches, original ideas, and unique perspectives; which are specifically tailored to the specific domain.

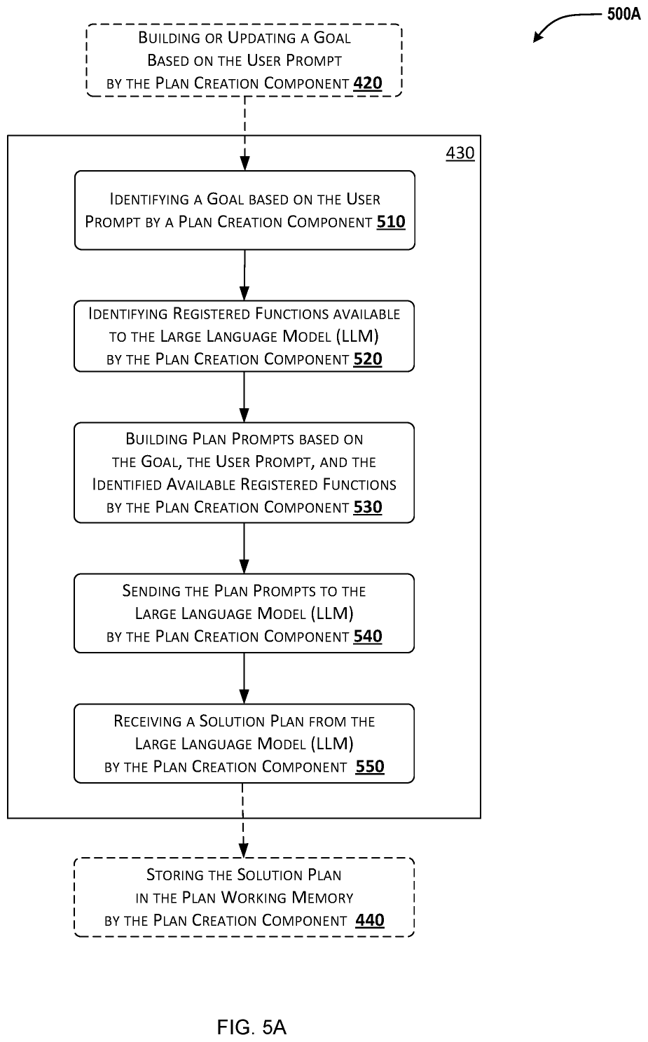

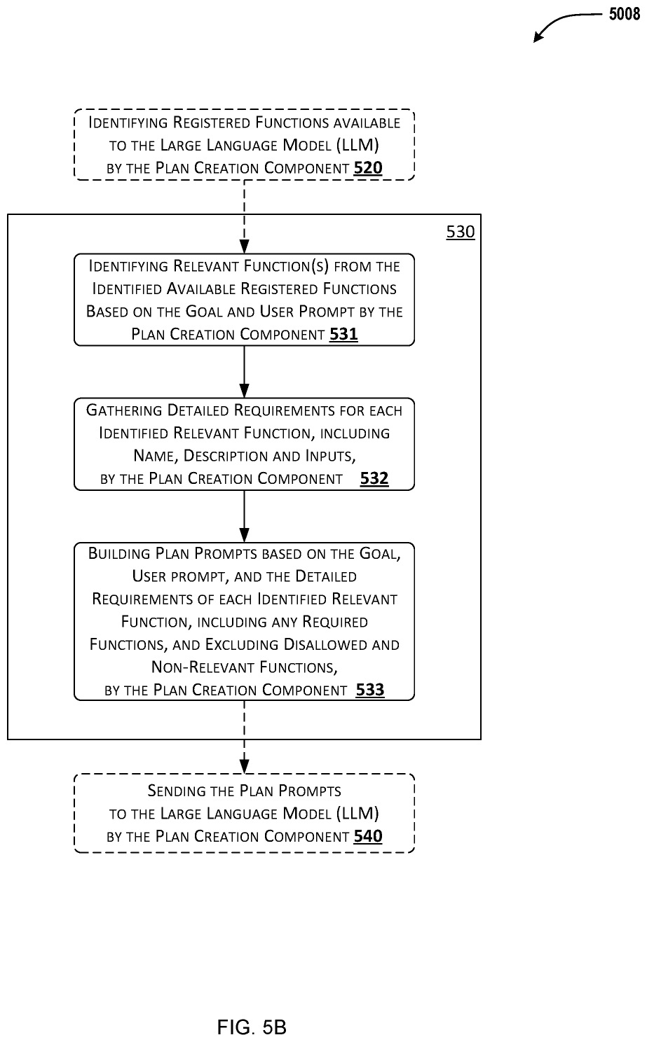

FIG. 5A is an example flow diagram 500A for a plan creation component of an example system (e.g., 100, 200, etc.), arranged in accordance with various aspects described herein. As illustrated, the flow diagram 500A may be broken into various blocks or partitions, such as blocks 510, 520, 530, 540, and 550. Blocks 420 and 440 from FIG. 4 are also shown to illustrate the relationship to FIG. 5A. Processing for the various blocks of flow diagram 500A, which may be described as processes, methods, steps, or functions, may commence at block 510, which may be considered a first detailed step of block 430 from FIGS. 4A and 4B.

At block 510, “Identifying a Goal based on the User Prompt by a Plan Creation Component”, a goal is identified by a plan creation component, such as plan creation component 150 of FIG. 1 or 2. The goal (e.g., 156) is previously determined at block 420, where the goal may have been derived from one or more prompts to a large language mode (e.g., LLM 120), or embedded in a prompt, such as when being specified in an API call (e.g., API 114) by the user (e.g., 102). Block 510 may be followed by block 520.

At block 520, “Identifying Registered Functions available to the Large Language Model (LLM) by the Plan Creation Component”, a list of registered function 142 that are available to the large language mode (e.g., 120) is gathered by the plan creation component (e.g., 150). Although the list of registered functions 142, may correspond to a subset all available skills and resources 140, the list may generally include any number of functions, skills, and resources that are available to the LLM. Block 520 may be followed by block 530.

At block 530, “Building Plan Prompts based on the Goal, the User Prompt, and the Identified Available Registered Functions by the Plan Creation Component”, a set of plan prompts may be built by the plan creation component (e.g., 150). The set of plan prompts (e.g., 152) may include: the goal (e.g., 154), the user prompt (e.g., 112), the list of registered function (e.g., 142), and any other previously supplied inputs (e.g., data inputs) that may have been supplied. Block 530 may be followed by block 540.

At block 540, “Sending the Plan Prompts to the Large Language Model (LLM) by the Plan Creation Component”, set of plan prompts (e.g., 152) previously build at block (530) are sent to the large language model (LLM) for processing. The LLM (e.g., 120) receives the prompts and processes them by applying a variety of NLP, deep learning, and sematic analysis to identify a relevant solution for the goal. Block 540 may be followed by block 550.

At block 550, “Receiving a Solution Plan from the Large Language Model (LLM) by the Plan Creation Component”, the solution plan is received from the large language model by the plan creation component (e.g., 160). The solution plan (e.g., 154) may include a set steps for execution of registered functions, accessing resource, as well as control flow logic such as conditionals and loops. Block 550 may be followed by block 440, as previously described

FIG. 5B is another example flow diagram 500B for a plan creation component of an example system (e.g., 100, 200, etc.), arranged in accordance with various aspects described herein. As illustrated, the flow diagram 500B may be broken into various blocks or partitions, such as blocks 531, 532, and 533. Blocks 520 and 540 from FIG. 5A are also shown to illustrate the relationship to FIG. 5B. Processing for the various blocks of flow diagram 500B, which may be described as processes, methods, steps, or functions, may commence at block 531, which may be considered a first detailed step of block 530 from FIG. 5A.

At block 531, “Identifying Relevant Function(s) from the Identified Available Registered Functions Based on the Goal and User Prompt by the Plan Creation Component”, relevant functions are identified by a plan creation component, such as plan creation component 150 of FIG. 1 or 2. The relevance of the registered functions, as well as the skills and resources available to the LLM (e.g., 120), are ranked based on sematic analysis, proximity to goals and prompts, as well as and other machine learning processes. Functions identified as non-relevant are excluded from consideration. Additionally, functions embedded in the solution plan or specified by the user as required to be included or excluded, are either added or removed from the list of relevant functions, as required. Block 531 may be followed by block 532.

At block 532, “Gathering Detailed Requirements for each Identified Relevant Function, including Name, Description and Inputs, by the Plan Creation Component”, detailed requirements are gathered by the plan creation component. The detailed requirements include, for each function identified as relevant, the name of the function, the description of the function, and the required inputs. Block 532 may be followed by block 533.

At block 533, “Building Plan Prompts based on the Goal, User prompt, and the Detailed Requirements of each Identified Relevant Function, including any Required Functions, and Excluding Disallowed and Non-Relevant Functions, by the Plan Creation Component”, the plan prompts for the LLM (e.g., 120) are assembled in order, based on their relevance and context. The plan prompts include the relevant functions and their detailed requirements, the user prompts, the goal, as well as the inputs necessary for the required functions. Excluded and non-relevant functions are not included in the plan prompts. Block 533 may be followed by block 540 as, as previously described.

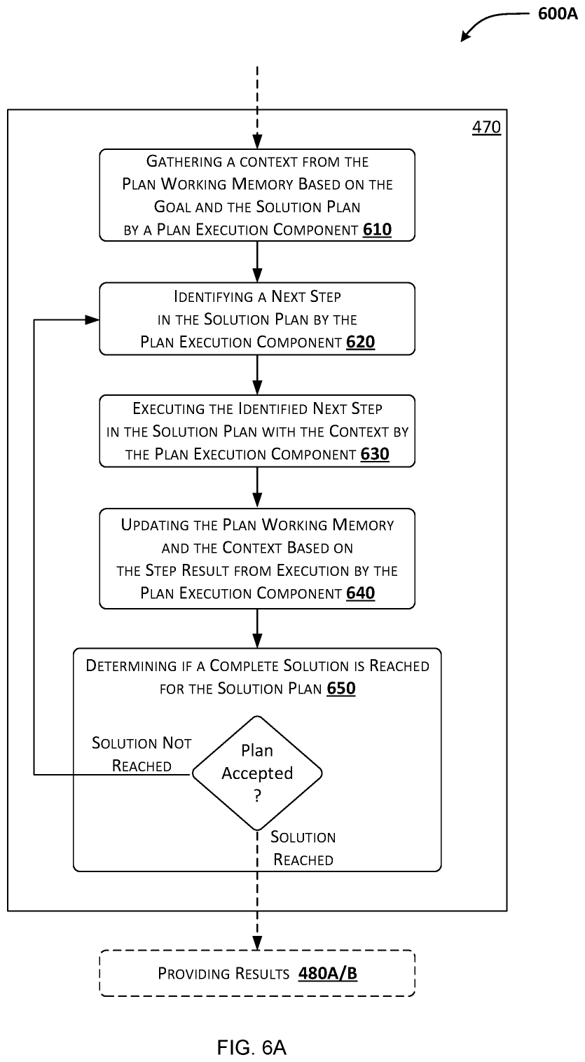

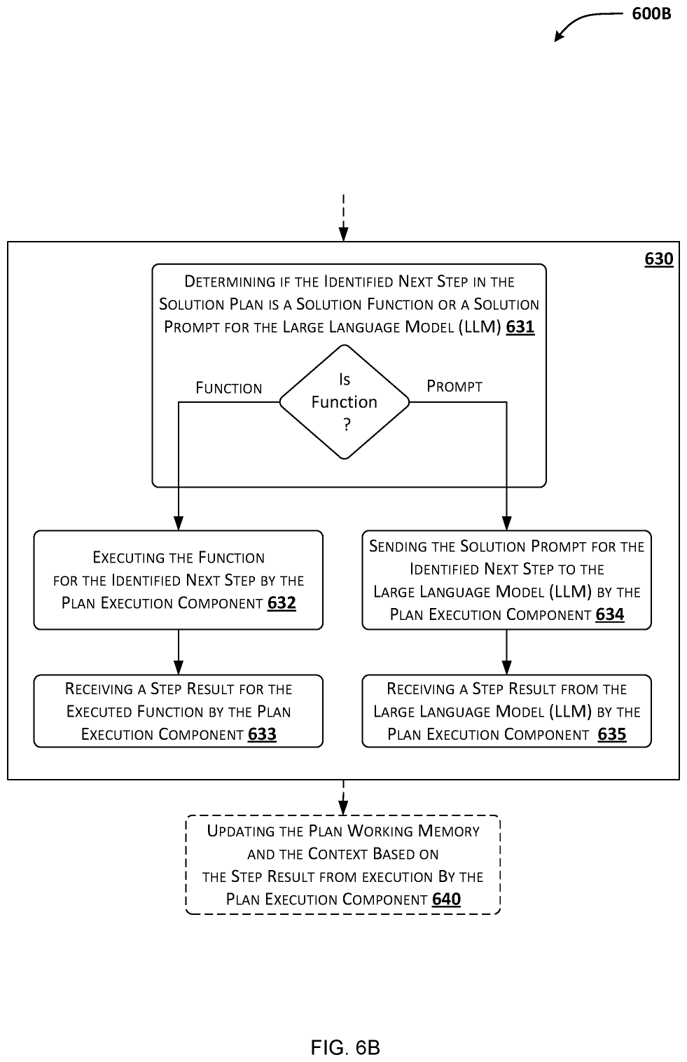

FIG. 6A is an example flow diagram 600A for a plan execution component of an example system (e.g., 100, 200, etc.), arranged in accordance with various aspects described herein. As illustrated, the flow diagram 600A may be broken into various blocks or partitions, such as blocks 610, 620, 630, 640, and 650. Block 480A/B is shown to reference the corresponding blocks from FIGS. 4A and 4B, to illustrate the relationship to FIG. 6A. Processing for the various blocks of flow diagram 600A, which may be described as processes, methods, steps, or functions, may commence at block 610, which may be considered a first detailed step of block 470 from FIGS. 4A and 4B.

At block 610, “Gathering a context from the Plan Working Memory Based on the Goal and the Solution Plan by a Plan Execution Component”, the context associated with the plan working memory (e.g., 160) and the solution plan is gathered by the plan execution component (e.g., 170). The context may also be determined from embeddings and other information associated with the goal (e.g., 156), the prompts (e.g., 112), and any data and requirements of the functions identified in the steps solution plan (e.g., 154). Block 610 may be followed by block 620 as, as previously described.

At block 620, “Identifying a Next Step in the Solution Plan by the Plan Execution Component”, the next step in the solution plan is identified by plan execution component (e.g., 170). The next step may include the execution of functions, skills, or access to resources, as well as program control flow logic or conditional evaluations, as previously described. Block 620 may be followed by block 630.

At block 630, “Executing the Identified Next Step in the Solution Plan with the Context by the Plan Execution Component”, the next step identified in block 620 is executed by the plan execution component (e.g., 170), oriented by the context of the plan working memory (e.g., 160) and goals. Thus, the results from the execution of any functions, skills, or access to resources, will be biased, filtered, or organized based on relevance to the context of the plan working memory and goals. Block 630 may be followed by block 640.

At block 640, “Updating the Plan Working Memory and the Context Based on the Step Result from Execution by the Plan Execution Component”, both the plan working memory (e.g., 160) and the context of the plan working memory will be updated by the plan execution component (e.g., 170) based on the results obtained from the execution at block 630. Block 640 may be followed by block 650.

At block 650, “Determining if a Complete Solution is Reached for the Solution Plan”, the results of the last executed step of the solution plan are evaluated by the plan execution component (e.g., 170) to determine if a complete solution is reached. For example, after execution of all of the steps of the solution plan, the solution plan may be considered completed. In other examples, the program control flow logic in the solution plan itself may identify conditions for task completion. If the plan execution component (e.g., 170) determines that a solution has not been reached, then processing continues from block 650 to block 620. If the plan execution component (e.g., 170) determines that a solution has been reached, then the results may be provided, and processing continues from block 650 to block 480A or 480B, as previously described.

FIG. 6B is another example flow diagram 600B for a plan execution component of an example system (e.g., 100, 200), arranged in accordance with aspects described herein. As illustrated, the flow diagram 600B may be broken into various blocks or partitions, such as blocks 631, 632, 633, 634 and 635. Block 640 from FIG. 6A is also shown to illustrate the relationship to FIG. 6B. Processing for the various blocks of flow diagram 600B, which may be described as processes, methods, steps, or functions, may commence at block 631, which may be considered a first detailed step of block 630 from FIG. 6A.

At block 631, “Determining if the Identified Next Step in the Solution Plan is a Solution Function or a Solution Prompt for the Large Language Model (LLM)”, the plan execution component evaluates the next step to be executed to determine if the next step is a function or a solution prompt. When the next step in the solution plan (e.g., 156) corresponds to a function, then processing continues from block 631 to block 632. When the next step corresponds to a solution prompt, then processing continues from block 631 to block 634.

At block 632, “Executing the Function for the Identified Next Step by the Plan Creation Component”, the plan execution component (e.g., 170) executes the function for the identified step in the solution plan (e.g., 156). As described previously, the function may correspond to any one of the registered functions, skills or resources that are available to the LLM (e.g., 120). Processing continues from block 632 to block 633.

At block 633, “Receiving a Step Result for the Executed Function by the Plan Execution Component”, where the plan execution component (e.g., 170) receives the results from the executed step of the solution plan (e.g., 156) which correspond to a result of the executed function. The results may thus comprise one step in the overall solution to achieve the goal. Processing continues from block 633 to block 640, which was previously described.

At block 634, “Sending the Solution Prompt for the Identified Next Step to the Large Language Model (LLM) by the Plan Creation Component”, the plan execution component (e.g., 170) sends the solution prompt for the next step in the solution plan to the LLM (e.g., 120). The LLM receives the solution prompt and may start to process the solution prompt, applying all resources available to the LLM to respond to the prompt. Processing continues from block 634 to block 635.

At block 635, “Receiving a Step Result from the Large Language Model (LLM) by the Plan Execution Component”, the plan execution component (e.g., 170) receives the results from the executed step of the solution plan (e.g., 156), which correspond to a response to the solution prompt by the LLM. The results may thus comprise one step in the overall solution to achieve the goal. Processing continues from block 635 to block 640, which was previously described.

The particular implementation of the technologies disclosed herein is a matter of choice dependent on the performance and other requirements of a computing device. Accordingly, the logical operations described herein are referred to variously as states, operations, structural devices, acts, modules, or components. These states, operations, structural devices, acts, modules, or components can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

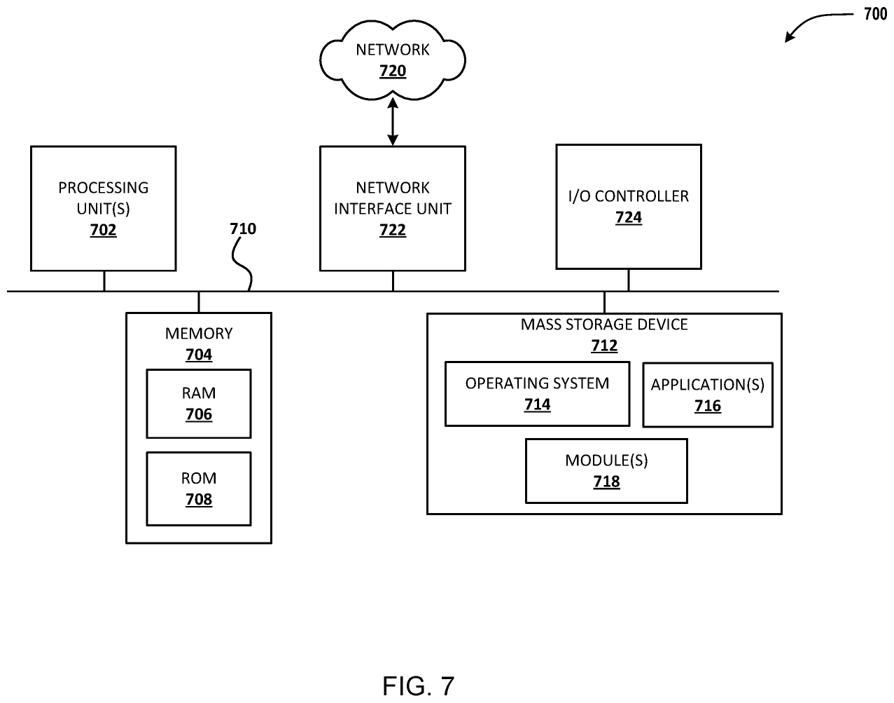

FIG. 7 shows additional details of an example computer architecture 700 for a device, such as a computer or a server configured as part of the systems (e.g., 100, 200, etc.) described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s) or processor(s), such as processing unit(s) 702, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

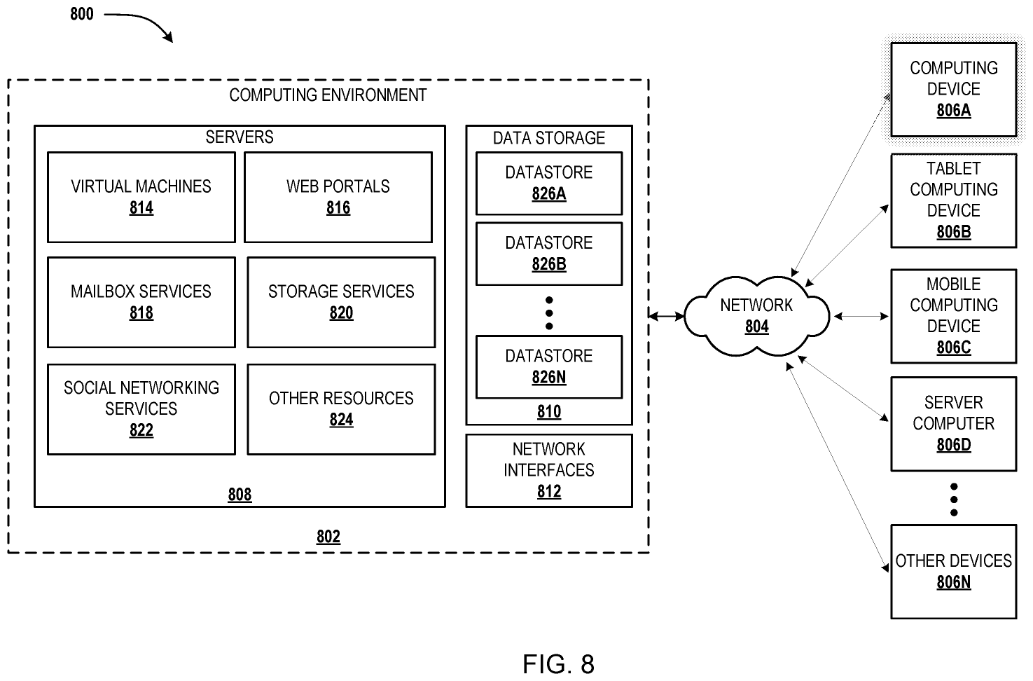

FIG. 8 depicts an illustrative distributed computing environment 800 capable of executing the software components described herein. Thus, the distributed computing environment 800 illustrated in FIG. 8 can be utilized to execute any aspects of the software components presented herein. For example, the distributed computing environment 800 can be utilized to execute aspects of the software components described herein.

Accordingly, the distributed computing environment 800 can include a computing environment 802 operating on, in communication with, or as part of the network 804. The network 804 can include various access networks. One or more client devices 806A-806N (hereinafter referred to collectively and/or generically as “clients 806” and also referred to herein as computing devices 806) can communicate with the computing environment 802 via the network 804. In one illustrated configuration, the clients 806 include a computing device 806A such as a laptop computer, a desktop computer, or other computing device; a slate or tablet computing device (“tablet computing device”) 806B; a mobile computing device 806C such as a mobile telephone, a smart phone, or other mobile computing device; a server computer 806D; and/or other devices 806N. It should be understood that any number of clients 806 can communicate with the computing environment 802.

In various examples, the computing environment 802 includes servers 808, data storage 810, and one or more network interfaces 812. The servers 808 can host various services, virtual machines, portals, and/or other resources. In the illustrated configuration, the servers 808 host virtual machines 814, Web portals 816, mailbox services 818, storage services 820, and/or, social networking services 822. As shown in FIG. 8 the servers 808 also can host other services, applications, portals, and/or other resources (“other resources”) 824.

As mentioned above, the computing environment 802 can include the data storage 810. According to various implementations, the functionality of the data storage 810 is provided by one or more databases operating on, or in communication with, the network 804. The functionality of the data storage 810 also can be provided by one or more servers configured to host data for the computing environment 802. The data storage 810 can include, host, or provide one or more real or virtual datastores 826A-826N (hereinafter referred to collectively and/or generically as “datastores 826”). The datastores 826 are configured to host data used or created by the servers 808 and/or other data. That is, the datastores 826 also can host or store web page documents, word documents, presentation documents, data structures, algorithms for execution by a recommendation engine, and/or other data utilized by any application program. Aspects of the datastores 826 may be associated with a service for storing files.

The computing environment 802 can communicate with, or be accessed by, the network interfaces 812. The network interfaces 812 can include various types of network hardware and software for supporting communications between two or more computing devices including, but not limited to, the computing devices and the servers. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 provides the software functionality described herein as a service to the computing devices.

It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 800 to utilize the functionality described herein for providing the techniques disclosed herein, among other aspects.

The present disclosure is supplemented by the following example clauses:

Example 1: A method for an artificial intelligence (AI) system (120) to automatically generate plans to solve problems, the method comprising: receiving an initial user prompt (410A, 410B) by a plan creation component (150) of the AI system (120); building an initial goal (420) based on the initial user prompt by the plan creation component (150) of the AI system (120); generating a solution plan (430) based on the initial goal and the initial user prompt by the plan creation component (150) of the AI system (120), wherein the plan creation component (150) uses a large language mode (LLM. 130) to generate a set of discrete steps for the solution plan to achieve the initial goal; storing the solution plan (440), the initial user prompt, and the initial goal in a plan working memory (160) of the AI system (120); and sending a message to the user that is based on one or more of the solution plan and the initial goal.

Example 2: The method of Example 1, wherein building the goal based on the initial user prompt comprises: building a goal prompt for the LLM based on the initial user prompt; sending the goal prompt to the LLM for processing; and responsive to sending the goal prompt to the LLM, receiving the initial goal from the LLM with the plan creation component.

Example 3: The method of Example 2, further comprising: receiving a subsequent user prompt by the plan creation component; building a subsequent goal prompt for the LLM based on the initial goal and the subsequent user prompt; sending the subsequent goal prompt to the LLM for processing; responsive to sending the subsequent goal prompt to the LLM, receiving a new goal from the LLM with the plan creation component; and storing the new goal in the plan working memory of the AI system.

Example 4: The method of Example 1, wherein generating the solution plan based on the initial goal comprises; building a plan prompt for the LLM based on the initial user prompt and the initial goal; sending the plan prompt to the LLM for processing; responsive to sending the plan prompt to the LLM, receiving one or more steps of the solution plan from the LLM with the plan creation component; and storing the received one or more steps of the solution plan in the plan working memory of the AI.

Example 5: The method of Example 1, wherein generating the solution plan based on the initial goal comprises: identifying skills, resources, and registered functions available to the LLM with the plan creation component; building one or more plan prompts for the LLM based on the initial goal, the initial user prompt, and one or more of the identified skills, resources, and available registered functions with the plan creation component; sending one or more of the plan prompts to the LLM for processing; responsive to sending the one or more plan prompts to the LLM, receiving one or more steps of the solution plan from the LLM with the plan creation component; and storing the received one or more steps of the solution plan in the plan working memory of the AI.

Example 6: The method of Example 5, wherein identifying skills and resources comprises identifying a web search skill or resource, a database skill or resource, file i/o skill or resource, an email skill or resource, an external API, an local API, code written by the AI, or other prompts from the AI.

Example 7: The method of Example 1, wherein generating the solution plan based on the initial goal comprises: identifying relevant skills, resources, and registered functions available to the LLM with the plan creation component; gathering detailed requirements for each identified relevant skill, resource, and registered function with the plan creation component; building one or more plan prompts for the LLM based on the initial goal, the initial user prompt, and one or more of the identified relevant skills, resources, and available registered functions and their corresponding detailed requirements with the plan creation component; sending one or more of the plan prompts to the LLM for processing; responsive to sending one or more of the plan prompts to the LLM, receiving one or more steps of the solution plan from the LLM with the plan creation component; and storing the received one or more steps of the solution plan in the plan working memory of the AI.

Example 8: The method of Example 3, further comprising: building one or more subsequent plan prompts for the LLM based on the subsequent user prompt and the new goal; sending one or more of the subsequent plan prompts to the LLM for processing; responsive to sending one or more of the subsequent plan prompts to the LLM, receiving one or more new steps of the solution plan from the LLM with the plan creation component; and storing the received one or more new steps of the solution plan in the plan working memory of the AI.

Example 9: The method of Example 1, further comprising: receiving a subsequent user prompt by a plan execution component; based on the subsequent user prompt, identifying a manual definition for one of a new goal, a new solution, a function exclusion list, or a function including list; and updating the plan working memory based on the identified manual definition.

Example 10: The method of Example 1, further comprising: receiving a command to initiate execution with a plan execution component; responsive to the command, executing the steps of the solution plan stored in the plan working memory with the plan execution component; and providing the results of the executed solution plan to the user.

Example 11: The method of Example 10, wherein executing the steps of the solution plan further comprises: gathering a context from the plan working memory based on the initial goal and the solution plan with the plan execution component; identifying each next step in the solution plan with the plan execution component; executing each identified next step with the plan execution component to produce a step result; updating the plan working memory and the context based on the step result for each step; and providing the solution result to the user after a solution is determined to be reached by the plan execution component.

Example 12: The method of Example 11, wherein executing each identified next step further comprises: determining if the identified next step in the solution plan is a solution function or a solution prompt; when the next identified step is the solution function, executing the solution function with the plan execution component and receiving the step result for the executed solution function; and when the next identified step is a solution prompt, sending the solution prompt to the LLM and receiving the step result from the LLM.

Example 13: A computer-readable storage medium (712) having computer-executable instructions stored thereupon that, when executed by one or more processing units (702) of an AI system (120), cause the AI system (120) to: receive an initial user prompt (410A, 410B) by a plan creation component (150) of the AI system (120); build an initial goal (420) based on the initial user prompt by the plan creation component (150) of the AI system (120); generate a solution plan (430) based on the initial goal and the initial user prompt by the plan creation component (150) of the AI system (120), wherein the plan creation component (150) uses a large language mode (LLM, 130) to generate a set of discrete steps for the solution plan to achieve the initial goal; store the solution plan, the user prompt, and the initial goal in a plan working memory (160) of the AI system (120); and send a message to the user that is based on one or more of the solution plan and the initial goal.

Example 14: The computer-readable storage medium of example 13, wherein the computer-executable instructions stored thereupon, when executed by one or more processing units of the AI system, further cause the AI system to: identify relevant skills, resources, and registered functions available to the LLM with the plan creation component; gather detailed requirements for each identified relevant skill, resource, and registered function with the plan creation component; build the plan prompts for the LLM based on the initial goal, the initial user prompt, and one or more of the identified relevant skills, resources, and available registered functions and their corresponding detailed requirements with the plan creation component.

Example 15: The computer-readable storage medium of Example 13, wherein the computer-executable instructions stored thereupon, when executed by one or more processing units of the AI system, further cause the AI system to: receive a command to initiate execution with a plan execution component; responsive to the command, execute the steps of the solution plan stored in the plan working memory with the plan execution component; and provide the results of the executed solution plan to the user.

Example 16: The computer-readable storage medium of Example 15, wherein the computer-executable instructions stored thereupon, when executed by one or more processing units of the AI system, further cause the AI system to: gather a context from the plan working memory based on the initial goal and the solution plan with the plan execution component; identify each next step in the solution plan with the plan execution component; execute each identified next step with the plan execution component to produce a step result; update the plan working memory and the context based on the step result for each step; and provide the solution result to the user after a solution is determined to be reached by the plan execution component.

Example 17: An AI system (120), comprising: a processor (702); and a computer-readable storage medium (712) having computer-executable instructions stored thereupon that, when executed by the processor (702), cause the AI system to: receive an initial user prompt (410A, 410B) by a plan creation component (150) of the AI system (120); build an initial goal (420) based on the initial user prompt by the plan creation component (150) of the AI system (120); generate a solution plan (430) based on the initial goal and the initial user prompt by the plan creation component (150) of the AI system (120), wherein the plan creation component (150) uses a large language mode (LLM, 130) to generate a set of discrete steps for the solution plan to achieve the initial goal; store the solution plan (440), the user prompt, and the initial goal in a plan working memory (130, 704) of the AI system (120); and send a message to the user that is based on one or more of the solution plan and the initial goal.

Example 18: The AI system of Example 17, wherein the computer-readable storage medium having computer-executable instructions stored thereupon, when executed by the processor, further cause the AI system to: identify relevant skills, resources, and registered functions available to the LLM with the plan creation component; gather detailed requirements for each identified relevant skill, resource, and registered function with the plan creation component; build the plan prompts for the LLM based on the initial goal, the initial user prompt, and one or more of the identified relevant skills, resources, and available registered functions and their corresponding detailed requirements with the plan creation component.

Example 19: The AI system of Example 17, wherein computer-readable storage medium having computer-executable instructions stored thereupon, when executed by the processor, further cause the AI system to: receive a command to initiate execution with a plan execution component; responsive to the command, execute the steps of the solution plan stored in the plan working memory with the plan execution component; and provide the results of the executed solution plan to the user.

Example 20: The AI system of Example 19, wherein the computer-readable storage medium having computer-executable instructions stored thereupon, when executed by the processor, further cause the AI system to: gather a context from the plan working memory based on the initial goal and the solution plan with the plan execution component; identify each next step in the solution plan with the plan execution component; execute each identified next step with the plan execution component to produce a step result; update the plan working memory and the context based on the step result for each step; and provide the solution result to the user after a solution is determined to be reached by the plan execution component.

The above described techniques provide a robust solution to plan generation, where creation and execution of such generated plans that leverage skills and resources of an LLM provide numerous benefits. Some example features that solve a technical problem to achieve a technical result include one or more of dynamic generation of plans, leveraging of skills and resources of the LLM, efficient aggregation of multiple long inputs, employing working memory component, planning, and executing control flow logic, and defining the applicability domain.

For dynamic generation of plans, the described systems and methods are able to generate plans dynamically, which allows for a more comprehensive solution space with greater flexibility in executing tasks. This technical effect can be seen as an improvement in the efficiency and effectiveness of planning in AI systems, resulting in increased capabilities and improved performance.

For skills and resources, the described systems and methods are able to leverage the LLM's access to numerous skills and resources, including APIs to external and internal resources, databases, web searches, email, and other resources, which provides a more comprehensive solution space. This technical effect can be seen as an improvement in the capabilities and performance of the AI system by utilizing external and internal resources to enhance the quality and accuracy of solution plans.

For efficient aggregation of multiple long inputs, the described systems and methods are able to efficiently aggregate multiple long inputs in the execution of a task, while ensuring that the prompts for executing individual steps are properly sized to avoid token and buffer limits. This technical effect can be seen as an improvement in the efficiency and accuracy of processing long inputs in AI systems, resulting in improved performance and reduced processing overhead.

For the working memory component, the described systems and methods are able to employ a working memory component in the plans created and executed by the LLM, providing for a more dynamic and adaptive solution space as the memory can grow and evolve during plan execution. This technical effect can be seen as an improvement in the adaptability and dynamic nature of the solution plans in AI systems, resulting in enhanced performance and capabilities.

For control flow logic, the described systems and methods are able to plan and execute control flow logic like conditionals and loops, significantly increasing the capabilities regarding plan creation and execution. This technical effect can be seen as an improvement in the versatility and flexibility of the solution plans in AI systems, resulting in improved performance and expanded capabilities.

The above described techniques for solution plan generation and execution has applicability over multiple domains, including but not limited to, healthcare, manufacturing, logistics and supply chain management, energy management, and financial investments, to name a few. The descried systems can thus be tailored (e.g., trained), and provided with domain specific resources, skills, and other information to mitigate risks within these specific domains.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for an artificial intelligence (AI) system to automatically generate plans to solve problems, the method comprising:
receiving an initial user prompt by a plan creation component of the AI system;
building an initial goal based on the initial user prompt by the plan creation component of the AI system;
generating a solution plan based on the initial goal and the initial user prompt by the plan creation component of the AI system wherein the plan creation component uses a large language mode (LLM) to generate a set of discrete steps for the solution plan to achieve the initial goal;
storing the solution plan, the initial user prompt, and the initial goal in a plan working memory of the AI system; and
sending a message to the user that is based on one or more of the solution plan and the initial goal.

2. The method of claim 1, wherein building the goal based on the initial user prompt comprises:
building a goal prompt for the LLM based on the initial user prompt;
sending the goal prompt to the LLM for processing; and
responsive to sending the goal prompt to the LLM, receiving the initial goal from the LLM with the plan creation component.

3. The method of claim 2, further comprising:
receiving a subsequent user prompt by the plan creation component;
building a subsequent goal prompt for the LLM based on the initial goal and the subsequent user prompt;
sending the subsequent goal prompt to the LLM for processing;
responsive to sending the subsequent goal prompt to the LLM, receiving a new goal from the LLM with the plan creation component; and
storing the new goal in the plan working memory of the AI system.

4. The method of claim 1, wherein generating the solution plan based on the initial goal comprises:
building a plan prompt for the LLM based on the initial user prompt and the initial goal;
sending the plan prompt to the LLM for processing;
responsive to sending the plan prompt to the LLM, receiving one or more steps of the solution plan from the LLM with the plan creation component; and
storing the received one or more steps of the solution plan in the plan working memory of the AI.

5. The method of claim 1, wherein generating the solution plan based on the initial goal comprises:
identifying skills, resources, and registered functions available to the LLM with the plan creation component;
building one or more plan prompts for the LLM based on the initial goal, the initial user prompt, and the one or more of the identified skills, resources, and available registered functions with the plan creation component;
sending one or more of the plan prompts to the LLM for processing;
responsive to sending the one or more plan prompts to the LLM, receiving one or more steps of the solution plan from the LLM with the plan creation component; and
storing the received one or more steps of the solution plan in the plan working memory of the AI.

6. The method of claim 5, wherein identifying skills and resources comprises identifying a web search skill or resource, a database skill or resource, file i/o skill or resource, an email skill or resource, an external API, a local API, code written by the AI, or other prompts from the AI.

7. The method of claim 1, wherein generating the solution plan based on the initial goal comprises:
identifying relevant skills, resources, and registered functions available to the LLM with the plan creation component;
gathering detailed requirements for each identified relevant skill, resource, and registered function with the plan creation component;
building one or more plan prompts for the LLM based on the initial goal, the initial user prompt, and the one or more of the identified relevant skills, resources, and available registered functions and their corresponding detailed requirements with the plan creation component;
sending one or more of the plan prompts to the LLM for processing;
responsive to sending one or more of the plan prompts to the LLM, receiving one or more steps of the solution plan from the LLM with the plan creation component; and
storing the received one or more steps of the solution plan in the plan working memory of the AI.

8. The method of claim 3, further comprising:
building one or more subsequent plan prompts for the LLM based on the subsequent user prompt and the new goal;
sending one or more of the subsequent plan prompts to the LLM for processing;
responsive to sending one or more of the subsequent plan prompts to the LLM, receiving one or more new steps of the solution plan from the LLM with the plan creation component; and
storing the received one or more new steps of the solution plan in the plan working memory of the AI.

9. The method of claim 1, further comprising:
receiving a subsequent user prompt by a plan execution component;
based on the subsequent user prompt, identifying a manual definition for one of a new goal, a new solution, a function exclusion list, or a function including list; and
updating the plan working memory based on the identified manual definition.

10. The method of claim 1, further comprising:
receiving a command to initiate execution with a plan execution component;
responsive to the command, executing the steps of the solution plan stored in the plan working memory with the plan execution component; and
providing the results of the executed solution plan to the user.

11. The method of claim 10, wherein executing the steps of the solution plan further comprises:
gathering a context from the plan working memory based on the initial goal and the solution plan with the plan execution component;
identifying each next step in the solution plan with the plan execution component;
executing each identified next step with the plan execution component to produce a step result;
updating the plan working memory and the context based on the step result for each step; and
providing the solution result to the user after a solution is determined to be reached by the plan execution component.

12. The method of claim 11, wherein executing each identified next step further comprises:
determining if the identified next step in the solution plan is a solution function or a solution prompt;
when the next identified step is the solution function, executing the solution function with the plan execution component and receiving the step result for the executed solution function; and
when the next identified step is a solution prompt, sending the solution prompt to the LLM and receiving the step result from the LLM.

13. A computer-readable storage medium having computer-executable instructions stored thereupon that, when executed by one or more processing units of an AI system, cause the AI system to:
receive an initial user prompt by a plan creation component of the AI system;
build an initial goal based on the initial user prompt by the plan creation component of the AI system;
generate a solution plan based on the initial goal and the initial user prompt by the plan creation component of the AI system, wherein the plan creation component uses a large language mode (LLM) to generate a set of discrete steps for the solution plan to achieve the initial goal;
store the solution plan (440), the user prompt, and the initial goal in a plan working memory of the AI system; and
send a message to the user that is based on one or more of the solution plan and the initial goal.

14. The computer-readable storage medium of claim 13, wherein the computer-executable instructions stored thereupon, when executed by one or more processing units of the AI system, further cause the AI system to:
identify relevant skills, resources, and registered functions available to the LLM with the plan creation component;
gather detailed requirements for each identified relevant skill, resource, and registered function with the plan creation component; and
build the plan prompts for the LLM based on the initial goal, the initial user prompt, and the one or more of the identified relevant skills, resources, and available registered functions and their corresponding detailed requirements with the plan creation component.

15. The computer-readable storage medium of claim 13, wherein the computer-executable instructions stored thereupon, when executed by one or more processing units of the AI system, further cause the AI system to:
receive a command to initiate execution with a plan execution component;
responsive to the command, execute the steps of the solution plan stored in the plan working memory with the plan execution component; and
provide the results of the executed solution plan to the user.

16. The computer-readable storage medium of claim 15, wherein the computer-executable instructions stored thereupon, when executed by one or more processing units of the AI system, further cause the AI system to:
gather a context from the plan working memory based on the initial goal and the solution plan with the plan execution component;
identify each next step in the solution plan with the plan execution component;
execute each identified next step with the plan execution component to produce a step result;
update the plan working memory and the context based on the step result for each step; and
provide the solution result to the user after a solution is determined to be reached by the plan execution component.

17. An AI system, comprising:
a processor; and
a computer-readable storage medium having computer-executable instructions stored thereupon that, when executed by the processor, cause the AI system to:
receive an initial user prompt by a plan creation component of the AI system;
build an initial goal based on the initial user prompt by the plan creation component of the AI system;
generate a solution plan based on the initial goal and the initial user prompt by the plan creation component of the AI system, wherein the plan creation component uses a large language mode (LLM) to generate a set of discrete steps for the solution plan to achieve the initial goal;
store the solution plan, the user prompt, and the initial goal in a plan working memory of the AI system; and
send a message to the user that is based on one or more of the solution plan and the initial goal.

18. The AI system of claim 17, wherein computer-readable storage medium of having computer-executable instructions stored thereupon, when executed by the processor, further cause the AI system to:
identify relevant skills, resources, and registered functions available to the LLM with the plan creation component;
gather detailed requirements for each identified relevant skill, resource, and registered function with the plan creation component; and
build the plan prompts for the LLM based on the initial goal, the initial user prompt, and the one or more of the identified relevant skills, resources, and available registered functions and their corresponding detailed requirements with the plan creation component.

19. The AI system of claim 17, wherein the computer-readable storage medium having computer-executable instructions stored thereupon, when executed by the processor, further cause the AI system to:
receive a command to initiate execution with a plan execution component;
responsive to the command, execute the steps of the solution plan stored in the plan working memory with the plan execution component; and
provide the results of the executed solution plan to the user.

20. The AI system of claim 19, wherein the computer-readable storage medium having computer-executable instructions stored thereupon, when executed by the processor, further cause the AI system to:
gather a context from the plan working memory based on the initial goal and the solution plan with the plan execution component;
identify each next step in the solution plan with the plan execution component;
execute each identified next step with the plan execution component to produce a step result;
update the plan working memory and the context based on the step result for each step; and
provide the solution result to the user after a solution is determined to be reached by the plan execution component.
